(19) United States
(12) Patent Application Publication
(10) Pub. No.: US 2025/0078008 A1
(43) Pub. Date: Mar. 6, 2025

(54) PREDICTIVE ANALYSIS BASED ON AGGREGATED CORPORATE AND FINANCIAL DATA

(71) Applicant: iQuery Inc., Palm Harbor, FL (US)

(72) Inventors: Paul Toomey, Palm Harbor, FL (US); Mitchell Dimler, Tampa, FL (US)

(21) Appl. No.: 18/812,868

(22) Filed: Aug. 22, 2024

Related U.S. Application Data
(60) Provisional application No. 63/536,346, filed on Sep. 1, 2023.

(51) Int. Cl. G06Q 10/0639; G06Q 10/067

(52) U.S. Cl. CPC G06Q 10/06393; G06Q 10/067

(57) ABSTRACT

According to various embodiments described herein, mechanisms are provided for providing a single source for a wide range of data and predictive analyses, integrating data describing corporations, finances, stock performance, competition, educational institutions, and/or job markets, in any suitable combination. Various embodiments provide mechanisms for integrating any or all of such data to generate predictive analysis yield expected corporate and/or investment outcomes. In addition, the system and method described herein are able to create and answer questions in an outcome format that can be used to make financial decisions for investors, business executives, boards of directors, and/or the like. In particular, according to various embodiments, the system and method described herein are able to aggregate data from many different sources, such as for example nationwide jobs data, company information, stock portfolios, and/or educational data, and to provide accurate analytical forecasting based on such aggregated data.

### CROSS-REFERENCE TO RELATED APPLICATION

This application claims the benefit of U.S. Provisional Patent Application Ser. No. 63/536,346, filed on Sep. 1, 2023 and entitled “Predictive Analysis Based On Aggregated Corporate and Financial Data,” which is incorporated by reference as though set forth herein in its entirety.

### TECHNICAL FIELD

The present document relates to techniques for providing analytical forecasting based on aggregated data.

### BACKGROUND

Existing data aggregation techniques do not provide any mechanism for efficiently and effectively providing accurate analytical forecasting based on geographically diverse data describing entities such as companies, stocks, educational institutions, and/or the like. Rather, existing solutions tend to focus on single source implementations, and fail to capture data from a wide range of geographically diverse sources.

### SUMMARY

According to various embodiments described herein, mechanisms are provided for providing a single source for a wide range of data and predictive analyses and reports, integrating data describing entities such as corporations. Such data may include, for example, finances, stock performance, competition, educational institutions, and/or job markets, in various combinations. Mechanisms are described for aggregating any or all such data to generate predictive analysis describing expected corporate and/or investment outcomes. In addition, the system and method described herein can create and answer questions in an outcome format that can be used to make financial decisions for investors, business executives, boards of directors, Mergers & Acquisitions, and/or the like.

In particular, according to various embodiments, the system and method described herein are able to aggregate data from many geographically diverse sources, such as for example nationwide jobs data, company information, stock portfolios, and/or educational data, and to provide accurate analytical forecasting based on such aggregated data. The system and method can also create and/or assign dimensions for the collected data. Such dimensions may indicate, for example, different employers, subsidiaries, and/or the like.

In at least one embodiment, the described system and method use such aggregated data to generate and provide reports describing predicted outcomes, which may be used by prospective investors, corporate executives, investment bankers, and/or other interested parties.

A user may start using the system, for example, by searching for information related to specific companies and/or other entities. Any suitable mechanism may be used for such searching, including for example keyword search, geographical search, search by industry sector, and/or the like. Combinations of such search parameters may also be used, and the system can dynamically filter results according to parameters. For example, when the user selects a particular industry sector, the system can dynamically filter the displayed results, and/or it can also filter by other parameters such as employee group count, revenue, geographic location, state of incorporation, and/or the like. In addition, the system can provide functionality to generate custom queries via a custom query builder.

The system then automatically begins collecting information based on what the user is seeking. Such information may include, for example, information about major companies, universities, and/or other entities.

Once a company is displayed as a result of a search, the system may provide any suitable information about the company, such as for example, employee count, stock price (including, optionally, a live stock ticker), stock history, location of offices, information about board of directors, and/or the like. In addition, the system can display information about the particular job skills the company is seeking in prospective employees, historical job counts, competitor information (including how many jobs such competitors have posted over time), and/or profiles for such jobs.

In at least one embodiment, the system can also generate and display a map of candidates that meet the positions being posted by the company (candidate area distribution), as well as a map showing where the company has been focusing its hiring. Other useful geographical information may also be displayed, such as for example the number of people who have achieved a particular degree the company is seeking. Any or all of such geographical information may be displayed textually and/or graphically, and can be broken down to any suitable level of granularity, including for example, state, county, country, and/or any other region.

The system is also able to provide visibility as to which universities are graduating candidates having degrees and/or qualifications that the company is interested in; this may help the company make decisions as to where to focus hiring efforts and/or where to locate offices, hiring offices, and/or branches.

Further details and variations are described herein.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1 depicts an example of a functional architecture for implementing the system described herein according to one embodiment.

FIG. 2 depicts an example of a methodology for collecting corporate and/or financial data into a main database, according to one embodiment.

FIG. 3 depicts an example of a methodology for collecting job market data into databases, according to one embodiment.

FIG. 4 depicts an example of a methodology for collecting labor market data into databases, according to one embodiment.

FIG. 5A depicts an example of a user experience flow for a main screen, according to one embodiment.

FIG. 5B depicts an example of a user experience flow for a registration process, according to one embodiment.

FIG. 6 depicts an example of a user experience flow for a welcome screen, according to one embodiment.

FIG. 7 depicts an example of a dashboard including saved companies and saved queries, according to one embodiment.

FIG. 8 depicts an example of a user experience flow for searching for an industry, company, and/or industry sector, according to one embodiment.

FIG. 9 depicts an example of an industry search results screen, according to one embodiment.

FIG. 10 depicts an example of a customer criteria search screen, according to one embodiment.

FIG. 11 depicts an example of a job market information screen, according to one embodiment.

FIG. 12 depicts an example of a screen for graphically displaying candidate distribution and education graduates, according to one embodiment.

FIG. 13 depicts an overview of process steps for implementing the various techniques and functionality described herein, according to one embodiment.

FIG. 14 depicts an example of a home screen according to one embodiment.

FIG. 15 depicts an example of a login screen according to one embodiment.

FIG. 16 depicts an example of a sidebar that may be present on all screens in the system, according to one embodiment.

FIG. 17 depicts an example of a Search/Companies screen according to one embodiment.

FIG. 18 depicts an example of a display of search results including companies that meet the search criteria, according to one embodiment.

FIG. 19 depicts an example of an Industry Sector screen that lists industries by their NAICS (North American Industry Classification System) code, according to one embodiment.

FIG. 20 depicts an example of an Industry Search screen that may be a further definition of the Industry Sector, according to one embodiment.

FIG. 21 depicts an example of a Headquarters Search screen according to one embodiment.

FIG. 22 depicts an example of an Employee Count Group screen according to one embodiment.

FIG. 23 depicts an example of a Revenue Group screen according to one embodiment.

FIG. 24 depicts an example of a Custom Search Builder screen according to one embodiment.

FIG. 25 depicts examples of Data/Condition/Value drop-down lists that contain various search criteria, according to one embodiment.

FIG. 26 depicts an example of a display of results that may be presented to the user, according to one embodiment.

FIG. 27 depicts an example of the entire search screen, according to one embodiment.

FIG. 28 depicts an example of Dashboard according to one embodiment.

FIG. 29 depicts an example of a display of saved companies according to one embodiment.

FIG. 30 depicts an example of a Saved Search Window according to one embodiment.

FIG. 31 depicts an example of a Company Information screen according to one embodiment.

FIG. 32 depicts a portion of the example of FIG. 31, including a window that provides basic company information with a real time stock ticker, according to one embodiment.

FIG. 33 depicts a portion of the example of FIG. 31, including Headquarters information, along with a representation of stock information and historical stock information over a time period, according to one embodiment.

FIG. 34 depicts a portion of the example of FIG. 31, including Key Executives information, according to one embodiment.

FIG. 35 depicts a portion of the example of FIG. 31, including Stock Analysis, according to one embodiment.

FIG. 36 depicts an example of a Time Frame dropdown menu according to one embodiment.

FIG. 37 depicts a portion of the example of FIG. 31, including an example of a display of Skill/Tool/Certifications, according to one embodiment.

FIG. 38 depicts a portion of the example of FIG. 31, including an example of a display of Historic Job Counts, according to one embodiment.

FIG. 39 depicts a portion of the example of FIG. 31, including an example of a display of Active Jobs By SOC Group, according to one embodiment.

FIG. 40 depicts a portion of the example of FIG. 31, including an example of a display of Monthly Applies, according to one embodiment.

FIG. 41 depicts an example of a country Job Distribution display according to one embodiment.

FIG. 42 depicts an example of a state Job Distribution display, according to one embodiment.

FIG. 43 depicts an example of a Company Jobs Detail screen, which may be presented as a continuation of the example of FIG. 31, according to one embodiment.

FIG. 44 depicts a portion of the example of FIG. 43, including Detailed Occupations By Selected SOC Group, according to one embodiment.

FIG. 45 depicts a portion of the example of FIG. 43, including a display of Historic Job Counts, according to one embodiment.

FIG. 46 depicts a portion of the example of FIG. 43, including a country Candidate Area Distribution display, according to one embodiment.

FIG. 47 depicts an example of a state Candidate Area Distribution display, according to one embodiment.

FIG. 48 depicts a portion of the example of FIG. 43, including a Job Area Distribution display, according to one embodiment.

FIG. 49 depicts an example of a user interface for selecting a state by clicking on it, according to one embodiment.

FIG. 50 depicts an example of a user interface for selecting a state from a drop-down menu, according to one embodiment.

FIG. 51 depicts an example of a Job Distribution display for a state, according to one embodiment.

FIG. 52 depicts a portion of the example of FIG. 43, including an Education Completers display indicating how many job candidates are in the selected state, and the certificates and/or degrees that they have, according to one embodiment.

FIG. 53 depicts an example of a user interface for selecting highlighted links to see a display of schools for the completers, according to one embodiment.

FIG. 54 is a block diagram depicting a hardware architecture for implementing the techniques described herein according to one embodiment.

FIG. 55 is a block diagram depicting a hardware architecture for implementing the techniques described herein in a client/server environment, according to one embodiment.

### DETAILED DESCRIPTION OF THE EMBODIMENTS

The systems and methods set forth herein may be applied in many contexts in which it may be useful to aggregate data from different sources and to generate forecasts based on such data. Such techniques may be useful to perform analysis for many different purposes and associated with different products, services, companies, employees, and/or the like, and may be used to replace and/or enhance conventional mechanisms for performing such operations.

For illustrative purposes, the system and method are described herein in the context of aggregation of data for use in making corporate and financial decisions, wherein the aggregated data may include nationwide jobs data and/or the like. One skilled in the art will recognize, however, that similar techniques can be used in other contexts as well. For example, the techniques described herein can be used in any context in which it may be useful or appropriate to provide analytical forecasting based on aggregated data.

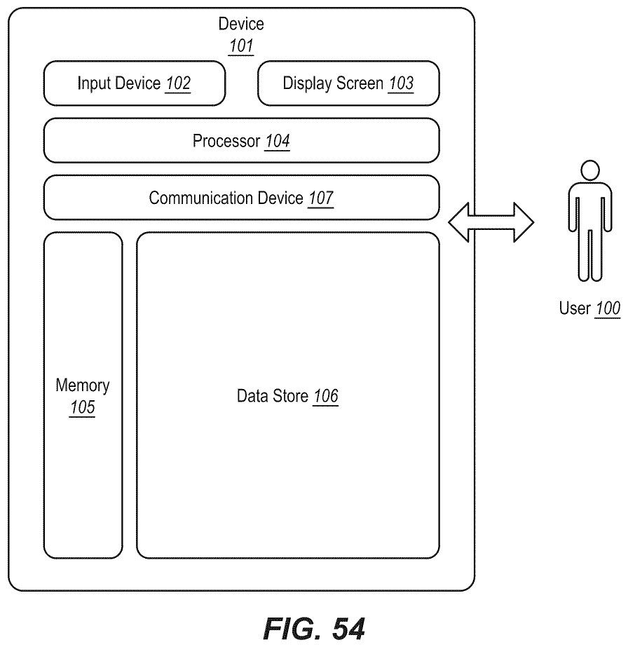

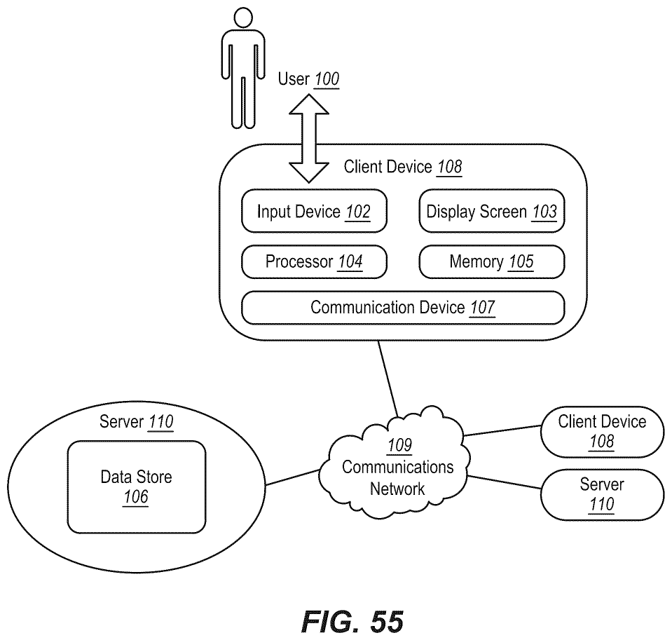

In some embodiments, one or more hardware and/or software components, as shown and described below in connection with FIGS. 54 and 55, may be used to implement the system and method described herein. In at least one embodiment, such components may be implemented in a cloud computing-based client/server architecture, using, for example, Amazon Web Services, which is an on-demand cloud computing platform available from Amazon.com, Inc. of Seattle, Washington. Therefore, for illustrative purposes, the system and method are described herein in the context of such an architecture. One skilled in the art will recognize, however, that the systems and methods described herein may be implemented using other architectures, such as for example a standalone computing device rather than a client/server architecture.

Further, the functions and/or method steps set forth herein may be carried out by software running on one or more of device(s) 101, client device(s) 108, server(s) 110, and/or other components. This software may optionally be multi-function software that is used to retrieve, store, manipulate, and/or otherwise use data stored in data storage devices and/or to carry out one or more other functions.

### Definitions and Concepts

For illustrative purposes and for ease of explanation, the following definitions and concepts are used herein:
A “customer”, “user”, or “end user”, such as user 100 referenced herein, may be an individual person, or may be an enterprise, company, family, representative, and/or group that may optionally include one or more individuals.
A “data store”, such as data store 106 referenced herein, may be any device capable of digital data storage, including any known hardware for nonvolatile and/or volatile data storage. A collection of data stores may form a “data storage system” that can be accessed by multiple customers.
A “computing device” or “device”, such as client device 101 or 108, is any electronic device capable of digital data processing. In at least one embodiment, the device may communicate with a server such as server 110, provide output to a customer, and accept input from a customer.
A “server”, such as server 110, may be a computing device that is configured to run software for back-end processing, and may also provide data storage, either via a local data store, or via connection to a remote data store.
An “entity” may be any individual or group of individuals, wherein such group may include a company, corporation, organization, firm, educational institution, team, religious organization, political party, and/or the like.

### System Architecture

According to various embodiments, the systems and methods described herein may be implemented on any electronic device or set of interconnected electronic devices, each equipped to receive, store, and present information. Each electronic device may be, for example, a server, desktop computer, laptop computer, smartphone, tablet computer, and/or the like. As described herein, some devices may be designated as client devices, which are generally operated by end users. Other devices may be designated as servers, which generally conduct back-end operations and communicate with client devices (and/or with other servers) via a communications network such as the Internet. In at least one embodiment, the techniques described herein may be implemented in a cloud computing environment using techniques that are known to those of skill in the art.

In addition, one skilled in the art will recognize that the techniques described herein may be implemented in other contexts, and indeed in any suitable device, set of devices, or system capable of interfacing with existing enterprise data storage systems. Accordingly, the following description is intended to illustrate various embodiments by way of example, rather than to limit scope.

Referring now to FIG. 54, there is shown a block diagram depicting a hardware architecture for practicing the described system, according to one embodiment. Such an architecture can be used, for example, for implementing the techniques of the system in a computer or other device 101. Device 101 may be any electronic device, including one of those listed above.

In at least one embodiment, device 101 includes a number of hardware components that are well known to those skilled in the art. Input device 102 can be any element that receives input from user 100, including, for example, a keyboard, mouse, stylus, touch-sensitive screen (touchscreen), touchpad, trackball, accelerometer, microphone, or the like. Input can be provided via any suitable mode, including for example, one or more of: pointing, tapping, typing, dragging, and/or speech. In at least one embodiment, input device 102 can be omitted or functionally combined with one or more other components.

Data store 106 can be any magnetic, optical, or electronic storage device for data in digital form; examples include flash memory, magnetic hard drive, CD-ROM, DVD-ROM, or the like. In at least one embodiment, data store 106 may store information that can be utilized and/or displayed according to the techniques described below. Data store 106 may be implemented in a database or using any other suitable arrangement. In another embodiment, data store 106 can be stored elsewhere, and data from data store 106 can be retrieved by device 101 when needed for processing and/or presentation to user 100. Data store 106 may store one or more data sets, which may be used for a variety of purposes and may include a wide variety of files, metadata, and/or other data.

In at least one embodiment, data store 106 may store data for performing various tasks and operations in connection with the functionality described herein, including for example collection data from various sources, performing aggregation and analysis on such data, and/or the like. In at least one embodiment, some or all of such data can be stored at another location, remote from device 101, and device 101 can access such data over a network, via any suitable communications protocol.

In at least one embodiment, data store 106 may be organized in a file system, using well-known storage architectures and data structures, such as relational databases. Examples include Oracle, MySQL, and PostgreSQL. Appropriate indexing can be provided to associate data elements in data store 106 with each other. In at least one embodiment, data store 106 may be implemented using cloud-based storage architectures such as NetApp (available from NetApp, Inc. of Sunnyvale, California) and/or Amazon Simple Storage Service (Amazon S3) (available from Amazon.com of Seattle, Washington).

Data store 106 can be local or remote with respect to the other components of device 101. In at least one embodiment, device 101 is configured to retrieve data from a remote data storage device when needed. Such communication between device 101 and other components can take place wirelessly, by Ethernet connection, via a computing network such as the Internet, via a cellular network, or by any other appropriate communication systems.

In at least one embodiment, data store 106 is detachable in the form of a CD-ROM, DVD, flash drive, USB hard drive, or the like. Information can be entered from a source outside of device 101 into data store 106 that is detachable, and later displayed after data store 106 is connected to device 101. In another embodiment, data store 106 is fixed within device 101.

In at least one embodiment, data store 106 may be organized into one or more well-ordered data sets, with one or more data entries in each set. Data store 106, however, can have any suitable structure. Accordingly, the particular organization of data store 106 need not resemble the form in which information from data store 106 is displayed to user 100 on display screen 103. In at least one embodiment, an identifying label may also be stored along with each data entry, to be displayed along with each data entry.

Display screen 103 can be any element that displays information such as text and/or graphical elements. In particular, display screen 103 may present a user interface for entering, viewing, configuring, selecting, editing, downloading, and/or otherwise interacting with data as described herein. In at least one embodiment where only some of the desired output is presented at a time, a dynamic control, such as a scrolling mechanism, may be available via input device 102 to change which information is currently displayed, and/or to alter the manner in which the information is displayed. In at least one embodiment, display screen 103 can be omitted or functionally combined with one or more other components.

Processor 104 can be a conventional microprocessor for performing operations on data under the direction of software, according to well-known techniques. Memory 105 can be random-access memory, having a structure and architecture as are known in the art, for use by processor 104 in the course of running software.

Communication device 107 may communicate with other computing devices via any known wired and/or wireless protocol(s). For example, communication device 107 may be a network interface card (“NIC”) capable of Ethernet communications and/or a wireless networking card capable of communicating wirelessly over any of the 802.11 standards. Communication device 107 may be capable of transmitting and/or receiving signals to transfer data and/or initiate various processes within and/or outside device 101.

Referring now to FIG. 55, there is shown a block diagram depicting a hardware architecture in a client/server environment, according to one embodiment. Such an implementation may use a “black box” approach, whereby data storage and processing are done completely independently from user input/output. An example of such a client/server environment is a web-based implementation, wherein client device 108 runs a browser that provides a user interface for interacting with web pages and/or other web-based resources from server 110. Items from data store 106 can be presented as part of such web pages and/or other web-based resources, using known protocols and languages such as Hypertext Markup Language (HTML), Java, JavaScript, and the like.

Client device 108 can be any electronic device incorporating input device 102 and/or display screen 103, such as a desktop computer, laptop computer, personal digital assistant (PDA), cellular telephone, smartphone, music player, handheld computer, tablet computer, kiosk, game system, wearable device, or the like. Any suitable type of communications network 109, such as the Internet, can be used as the mechanism for transmitting data between client device 108 and server 110, according to any suitable protocols and techniques. In addition to the Internet, other examples include cellular telephone networks, EDGE, 3G, 4G, 5G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 108 may transmit requests for data via communications network 109, and may receive responses from server 110 containing the requested data. Such requests may be sent via HTTP as remote procedure calls or the like.

In one implementation, server 110 may be responsible for data storage and processing, and may incorporate data store 106. Server 110 may include additional components as needed for retrieving data from data store 106 in response to requests from client device 108.

As described above in connection with FIG. 54, data store 106 may be organized into one or more well-ordered data sets, with one or more data entries in each set. Data store 106 can, however, have any suitable structure, and may store data according to any organization system known in the information storage arts, such as databases and other suitable data storage structures.

In addition to or in the alternative to the foregoing, data may also be stored in data store 106 that is part of client device 108. In some embodiments, such data may include elements distributed between server 110 and client device 108 and/or other computing devices in order to facilitate secure and/or effective communication between these computing devices.

As discussed above in connection with FIG. 54, display screen 103 can be any element that displays information such as text and/or graphical elements. Various user interface elements, dynamic controls, and/or the like may be used in connection with display screen 103.

As discussed above in connection with FIG. 54, processor 104 can be a conventional microprocessor for use in an electronic device to perform operations on data under the direction of software, according to well-known techniques. Memory 105 can be random-access memory, having a structure and architecture as are known in the art, for use by processor 104 in the course of running software. Communication device 107 may communicate with other computing devices using any known wired and/or wireless protocol(s), as discussed above in connection with FIG. 54.

In at least one embodiment, some or all of the system can be implemented as software written in any suitable computer programming language, whether in a standalone or client/server architecture. Alternatively, some or all of the system may be implemented and/or embedded in hardware.

Notably, multiple client devices 108 and/or multiple servers 110 may be networked together, and each may have a structure similar to those of client device 108 and server 110 that are illustrated in FIG. 55. The data structures and/or computing instructions used in the performance of methods described herein may be distributed among any number of client devices 108 and/or servers 110. As used herein, “system” may refer to any of the components, or any collection of components, from FIGS. 54 and/or 55, and may include additional components not specifically described in connection with FIGS. 54 and 55.

In some embodiments, data within data store 106 may be distributed among multiple physical servers. Thus, data store 106 may represent one or more physical storage locations, which may communicate with each other via the communications network and/or one or more other networks (not shown). In addition, server 110 as depicted in FIG. 55 may represent one or more physical servers, which may communicate with each other via communications network 109 and/or one or more other networks (not shown). Part of data store 106 may reside on device 101 and/or client device 108.

In one embodiment, some or all components of the system can be implemented in software written in any suitable computer programming language, whether in a standalone or client/server architecture. Alternatively, some or all components may be implemented and/or embedded in hardware.

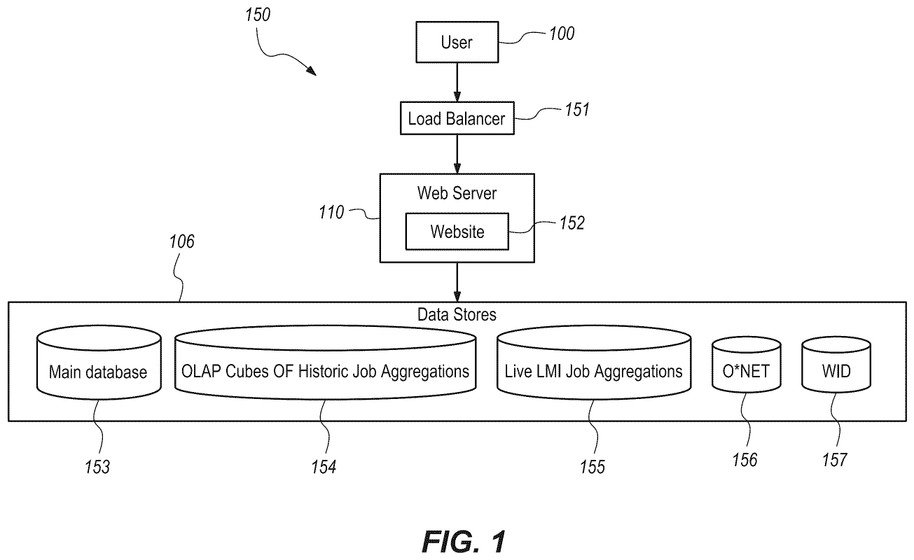

Referring now to FIG. 1, there is shown an example of a functional architecture 150 for implementing the system described herein according to one embodiment. In at least one embodiment, functional architecture 150 may be implemented using hardware components such as those described above in connection with FIGS. 54 and/or 55. One skilled in the art will recognize, however, that other hardware architectures can be used to implement the depicted functional architecture.

In connection with the functional architecture 150 depicted in FIG. 1, user 100 may access (via load balancer 151, if appropriate) website 152 provided via one or more web servers 110. Website 152 may access back-end data stores 106, which may include for example:
main database 153 containing processed data representing corporate and/or financial data;
database 154 storing Online Analytical Processing (OLAP) cubes containing historical job aggregations;
database 155 containing live Labor Market Information (LMI) job aggregations;
database 156 containing data related to the Occupational Information Network (O′NET); and/or
database 157 containing Workforce Information (WID).

In at least one embodiment, any or all of the databases may use propriety data structures, and may be implemented using any suitable tools and infrastructure, such as for example Microsoft SQL Server available from Microsoft Corporation of Redmond, Washington.

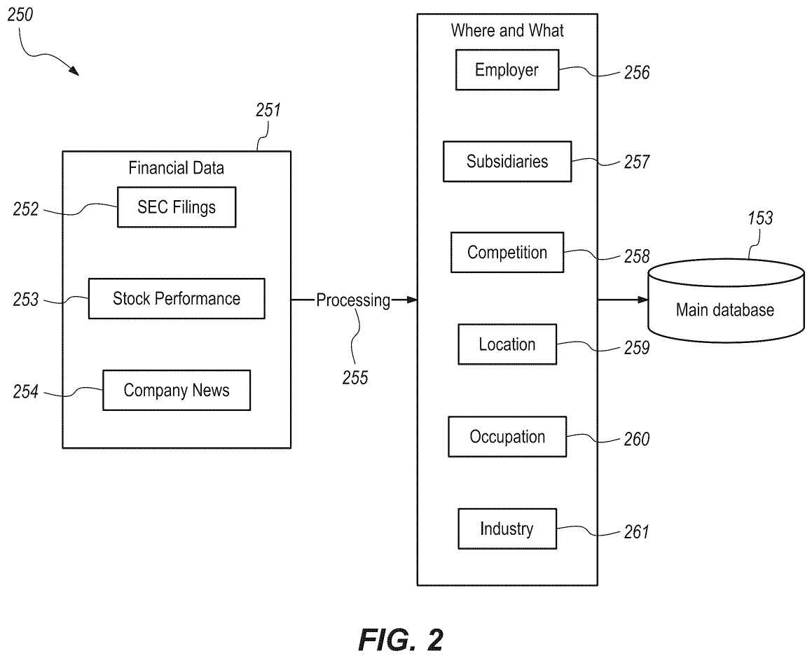

Data may be collected, processed, and stored in databases 153-157 in various ways. Referring now to FIGS. 2 through 4, there are shown examples of various methodologies by which data may be collected, processed, and stored.

Referring now to FIG. 2, there is shown an example 250 of a methodology for collecting corporate and/or financial data 251 into main database 153, according to one embodiment. Such data 251 may include, for example, SEC filings 252, stock performance data 253, company news 254, and/or the like. Processing 255 may be performed on such data 251, and the processed data may then be broken down by employer 256, subsidiaries 257, competition 258, location 259, occupation 260, and/or industry 261. The processed data may then be stored in main database 153.

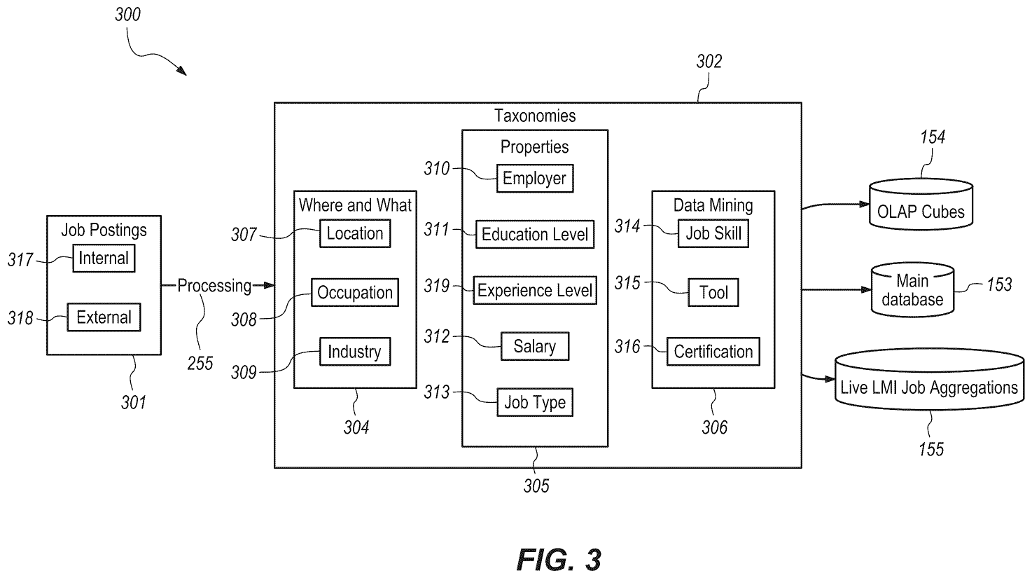

Referring now to FIG. 3, there is shown an example 300 of a methodology for collecting job market data into databases 153, 154, and 155. Such data may be collected from geographically diverse sources such as, for example, job postings 301, which may include internal job postings 317 and/or external job postings 318. Processing 255 may be performed on job postings data 301, and the processed data may be organized according to any suitable taxonomy or collection of taxonomies 302, which may include, for example, where and what 304 (location 307, occupation 308, and/or industry 309), properties 305 (employer 310, education level 311, experience level 319, salary 312, and/or job type 313), and/or data mining 306 (job skill 314, tool 315, and/or certification needed for jobs). Data organized by taxonomies may be stored in any combination of main database 153, OLAP cubes 154, and/or live LMI job aggregations 155.

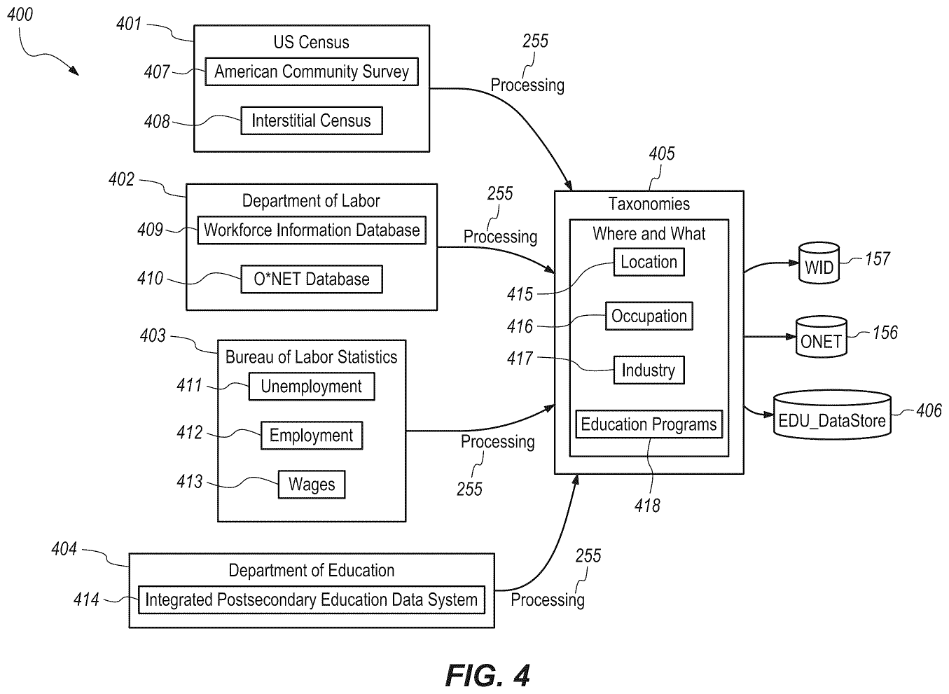

Referring now to FIG. 4, there is shown an example 400 of a methodology for collecting labor market data into databases 156 and 157, as well as EDU_DataStore database 406, according to one embodiment. In at least one embodiment, EDU_DataStore database 406 is used to store college/university information, such as for example, institution name, degree, population of graduates, all programs, related costs of education, and/or the like. Such data may be collected from geographically diverse sources such as, for example, US census data 401 (including, for example, American Community Survey data 407 and/or interstitial census data 408), Department of Labor data 402 (including, for example, workplace information database 409 and/or O′NET database 410), bureau of labor statistics data 403 (including, for example, unemployment data 411, employment data 412, and/or wages data 413), and/or Department of Education data 404 (including, for example, data 414 from an integrated postsecondary education data system). Processing 255 may be performed on data 301 from these various sources, and the processed data may organized according to any suitable taxonomy or collection of taxonomies 405 which may include, for example, location 415, occupation 416, industry 417, and/or education programs 418. Data organized by taxonomies 405 may be stored in any combination of a WID database 157, O′NET database 156, and EDU_DataStore database 406.

### Method

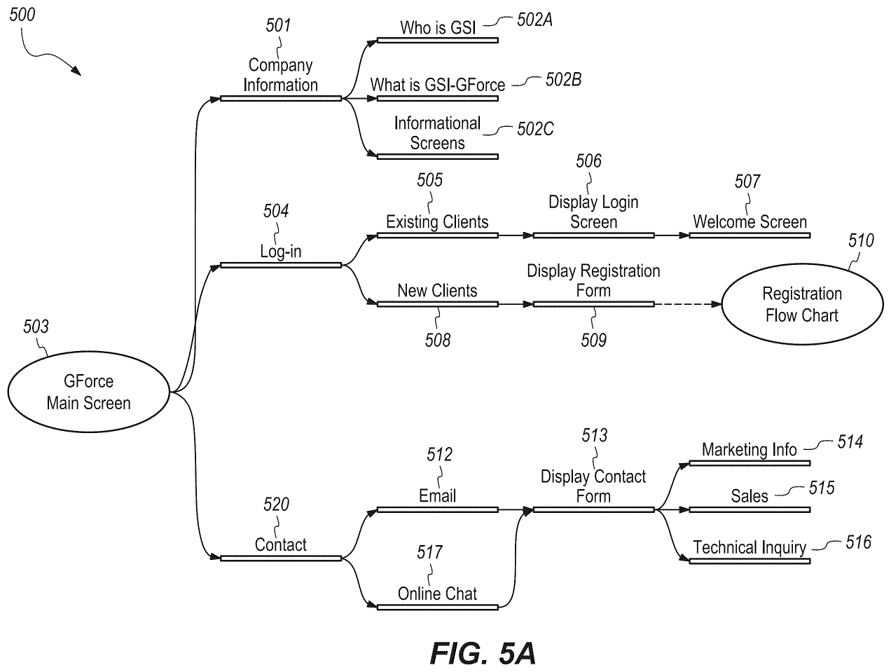

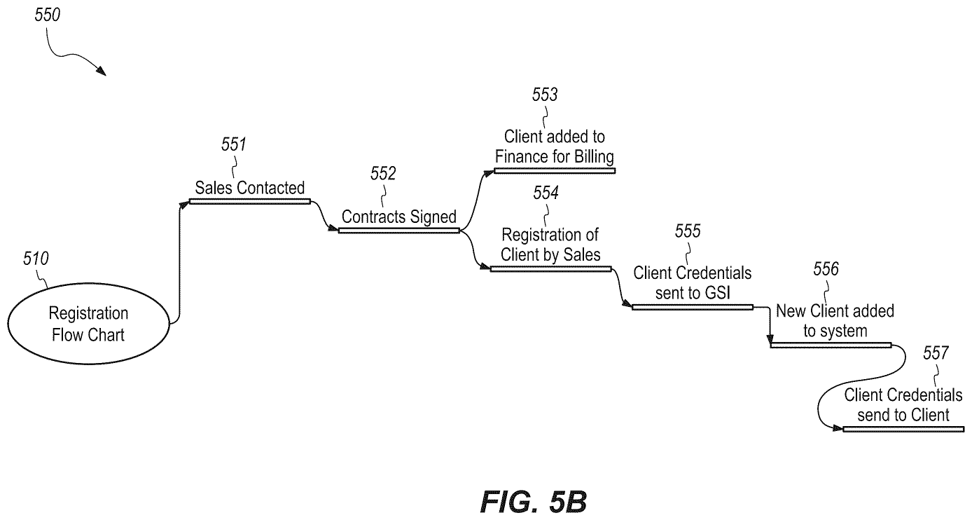

Referring now to FIG. 5A, there is shown an example of a user experience flow 500 for a main screen, according to one embodiment. Main screen 503 may provide access to company information 501, login path 504, and/or contact page(s) 520.

User 100 can access company information 501, including general information 502A-502C about who the system provider is, what the system provides, and other informational screens. User 100 can also access contact page(s) 520 for contacting the company, for example via email 512 of online chat 517, or by display 513 of a contact form which may provide direct access to contact information for marketing 514, sales 515, and/or technical department 516.

Login path 504 may allow user 100 to log in as an existing client 505, in which case a login screen is displayed 506, followed by a welcome screen 507. Alternatively, user 100 may log in as a new client 508, in which case a registration form is displayed 509, and a registration flow chart 510 is followed, as depicted in more detail in connection with FIG. 5B.

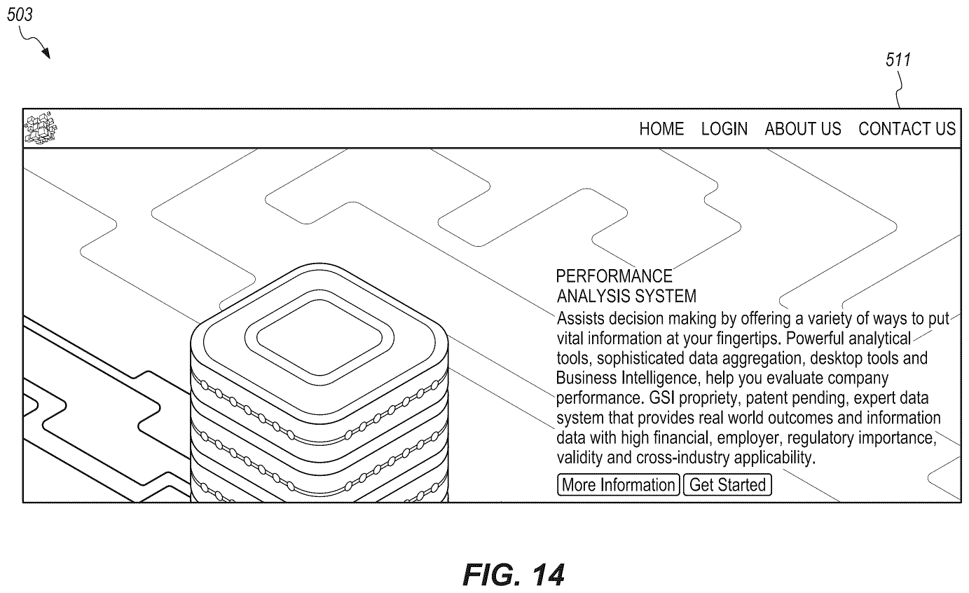

Referring now to FIG. 14, there is shown an example of a main screen 503 as may be presented according to one embodiment. In at least one embodiment, screen 503 may be the landing point after user 100 enters a URL to access the website that embodies the functionality described herein. From this screen 503, user 100 may have access to their login screen, as well as company information pages 501, which may describe the company, as well as its products and services. Screen 503 may also provide access to a Contact Us page (via link 511) that provides user 100 with an opportunity to request further assistance.

Referring now to FIG. 5B, there is shown an example 550 of a registration flow chart 510 according to one embodiment. The depicted registration process may include, for example, contacting sales 551, signing contracts 552, adding user 100 (client) to a finance system for billing 553, registering the client by a sales department 554, collecting client credentials 555, and adding the new client to the system 556. In addition, client credentials may be sent 557 to the client.

In at least one embodiment, the registration process depicted in FIG. 5B may be accessed via the Contact Us link 511 from main screen 503. The potential client may fill out a registration form that collects certain information that may allow the sales department to be notified. Once the client and the sales department have agreed to terms, registration process 510 may begin, payment may be collected, and credentials may be sent to the technical team to create a username and password for the client.

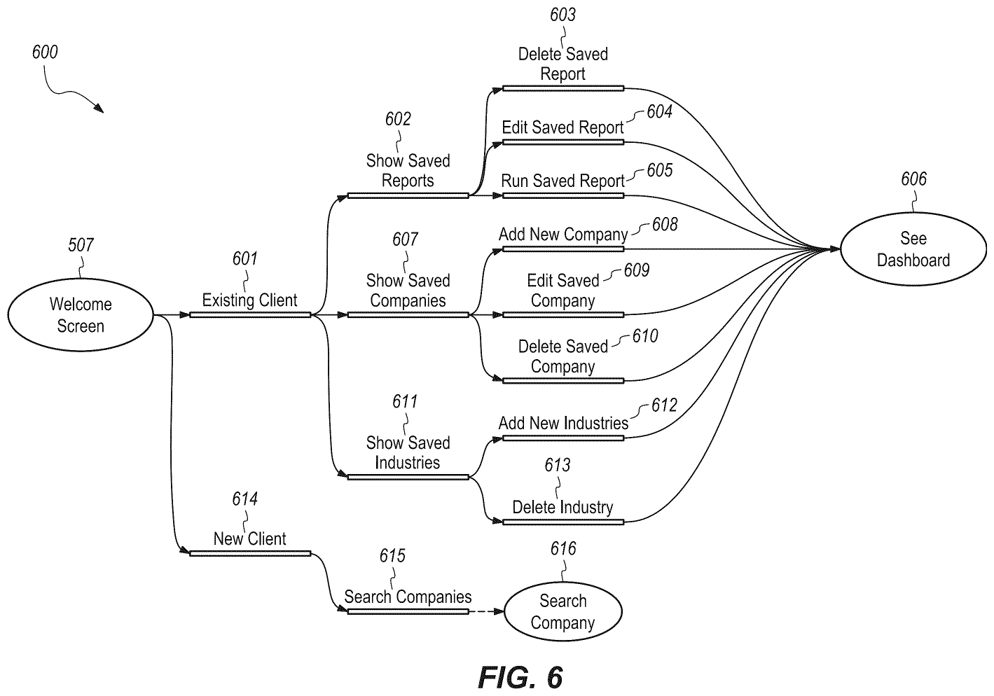

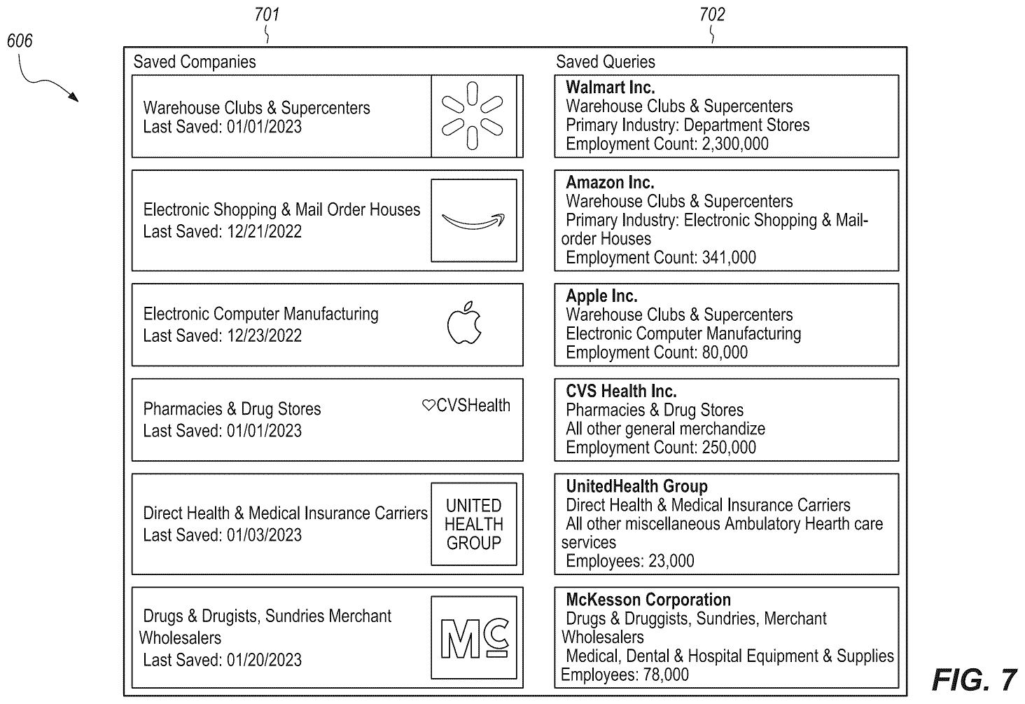

Referring now to FIG. 6, there is shown an example of a user experience flow 600 for welcome screen 507 according to one embodiment. If user 100 is a new client 6014, they may activate a search companies 615 option to be taken to a screen 616 for searching companies. If user 100 is an existing client 601, they may be taken to a screen where they can select among options including show saved reports 602 (including deleting 603, editing 604, and/or running 605 saved reports), show saved companies 607 (including adding a new company 608, editing a saved company 609, and deleting a saved company 610), and show saved industries 611 (including adding new industries 612 and deleting an industry 613). User 100 may also be given access to a dashboard 606, as depicted in FIG. 7.

Referring now to FIG. 7, there is shown an example of a dashboard 606 according to one embodiment, including saved companies 701 and saved queries 702. In at least one embodiment, user 100 may interact with saved companies 701 and saved queries 702 to see further details or perform further operations.

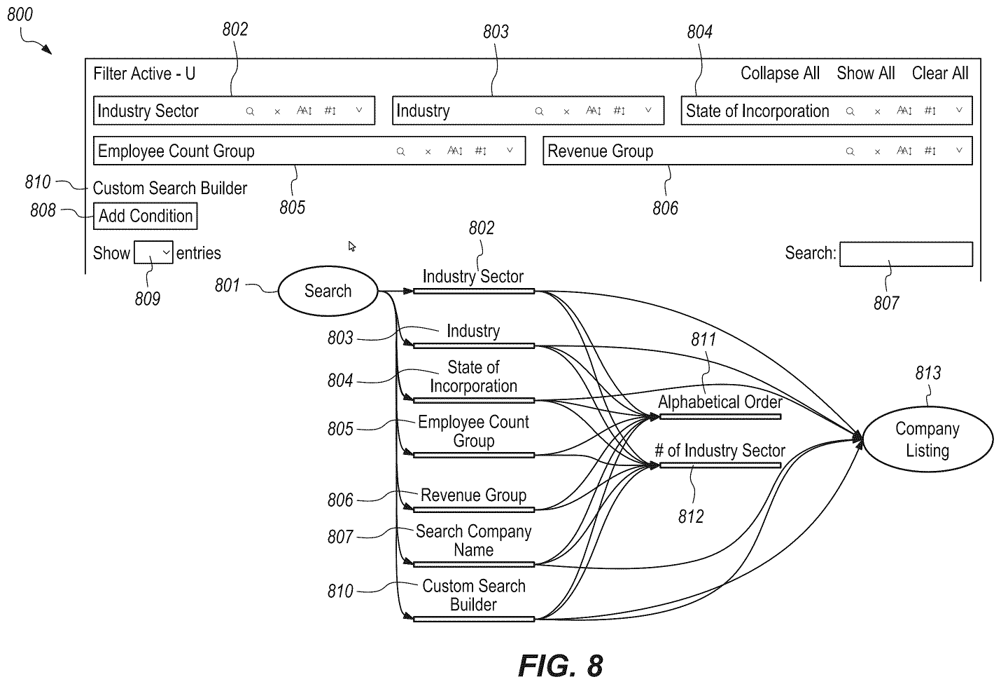

Referring now to FIG. 8, there is shown an example of a user experience flow 800 for searching for an industry, company, and/or industry sector, according to one embodiment. As shown in the example, searching may be performed by industry sector 802, industry 803, state of incorporation 804, employee count 805, revenue group 806, and/or company name 807. In addition, a custom search builder 810 may be provided, wherein user 100 can click Add Condition button 808 to add additional conditions for the search. Search results may be presented in alphabetical order 811 or by number of industry sector 812. Results may be presented in a manner that provides access to a company listing 813. Pull-down menu 809 may allow user 100 to specify how many entries should be shown per page.

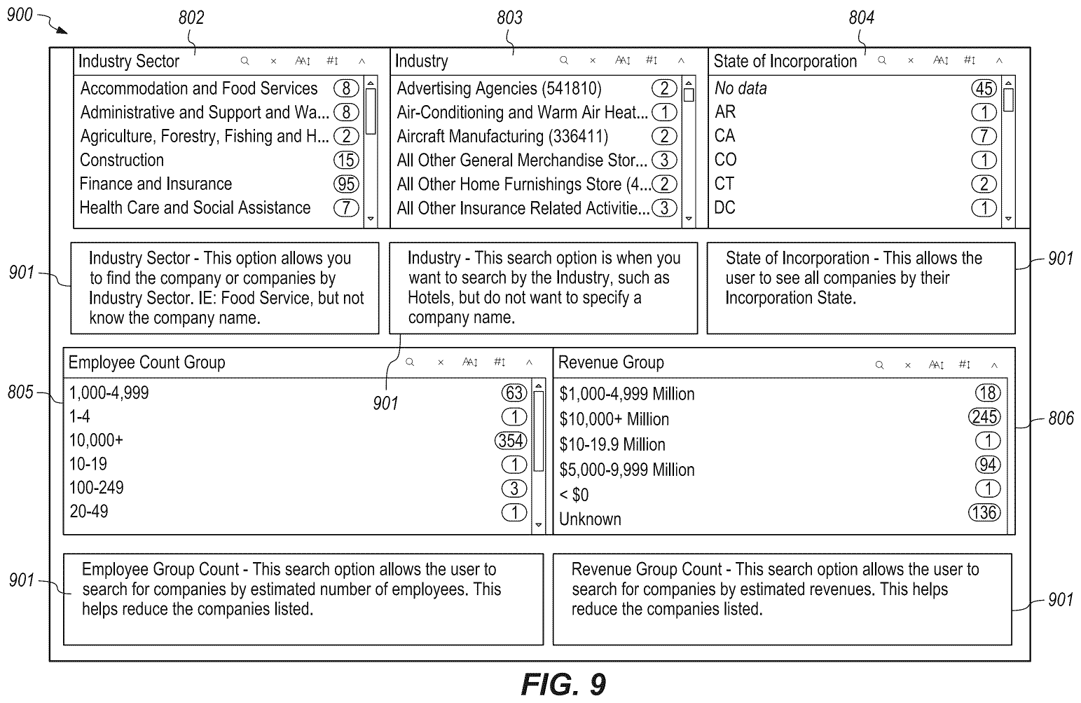

Referring now to FIG. 9, there is shown an example of an industry search results screen 900, as may be presented in response to a search performed according to the techniques depicted in FIG. 8, according to one embodiment. Industry Sector option 802 may allow user 100 to search for a company by industry sector. Industry option 803 may allow user 100 to search for companies by industry. State of Incorporation option 804 may allow user 100 to search for companies by state of incorporation. Employee Count Group option 805 may allow user 100 to search for companies by estimated number of employees. Revenue Group option 806 may allow user 100 to search for companies by estimated revenue. In at least one embodiment, descriptive information 901 may be provided for each search option.

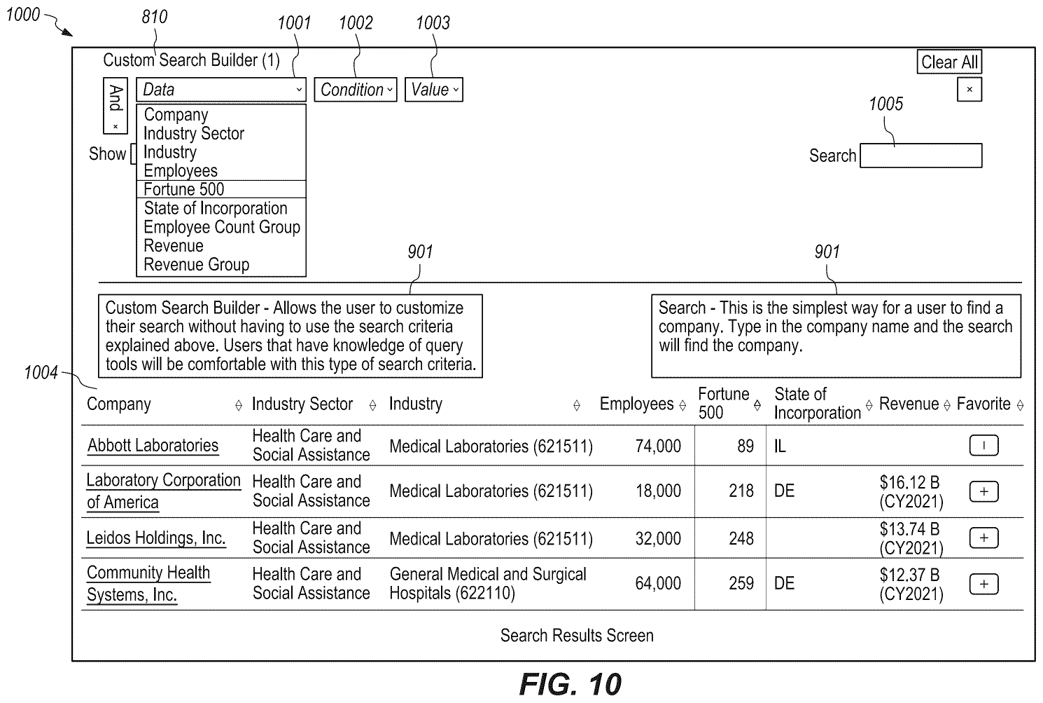

Referring now to FIG. 10, there is shown an example of a customer criteria search screen 1000, according to one embodiment. Custom search builder 810 may allow user 100 to specify which data element they wish to filter, and specify a condition and/or value. This may be done, for example, using pull-down menus 1001, 1002, and 1003. Alternatively, user 100 can enter a keyword search in search field 1005. Example search results 1004 are shown at the bottom of the screen. In at least one embodiment, descriptive information 901 may be provided for each search option.

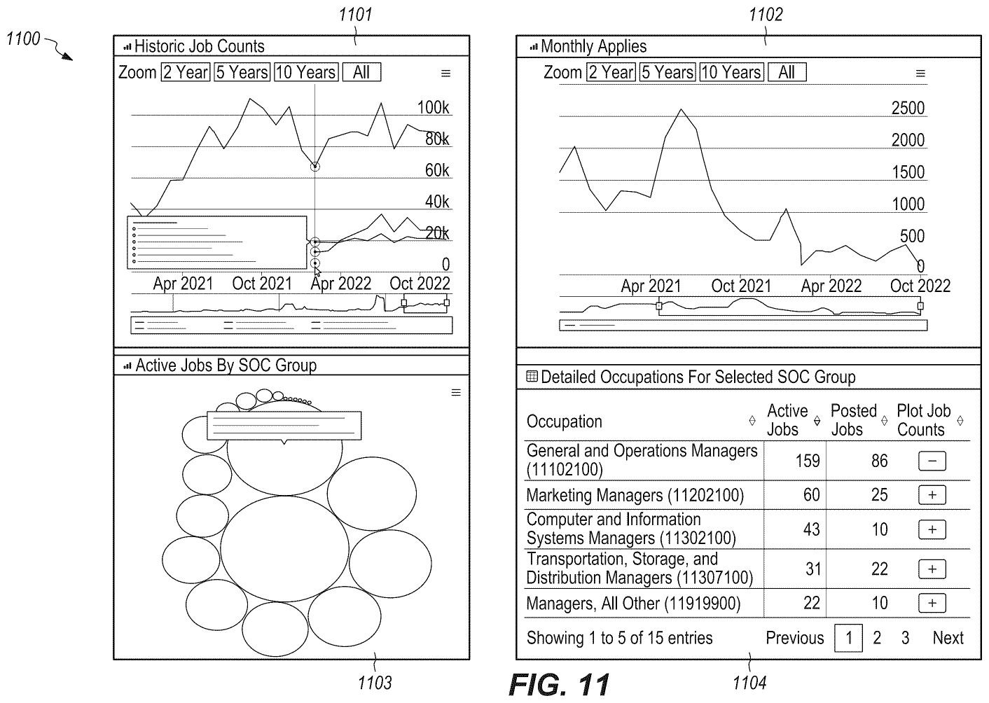

Referring now to FIG. 11, there is shown an example of a job market information screen 1100, according to one embodiment. At top left is an example of a graph 1101 depicting historic job counts. At top right is an example of a graph 1102 depicting monthly applies. At bottom left is a visual depiction 1103 of active jobs by Standard Occupational Classification (SOC) group. At bottom right is a chart 1104 indicating the number of active jobs and posted jobs for each of a number of occupations. One skilled in the art will recognize that these displays are merely exemplary, and that other types of displays may be provided.

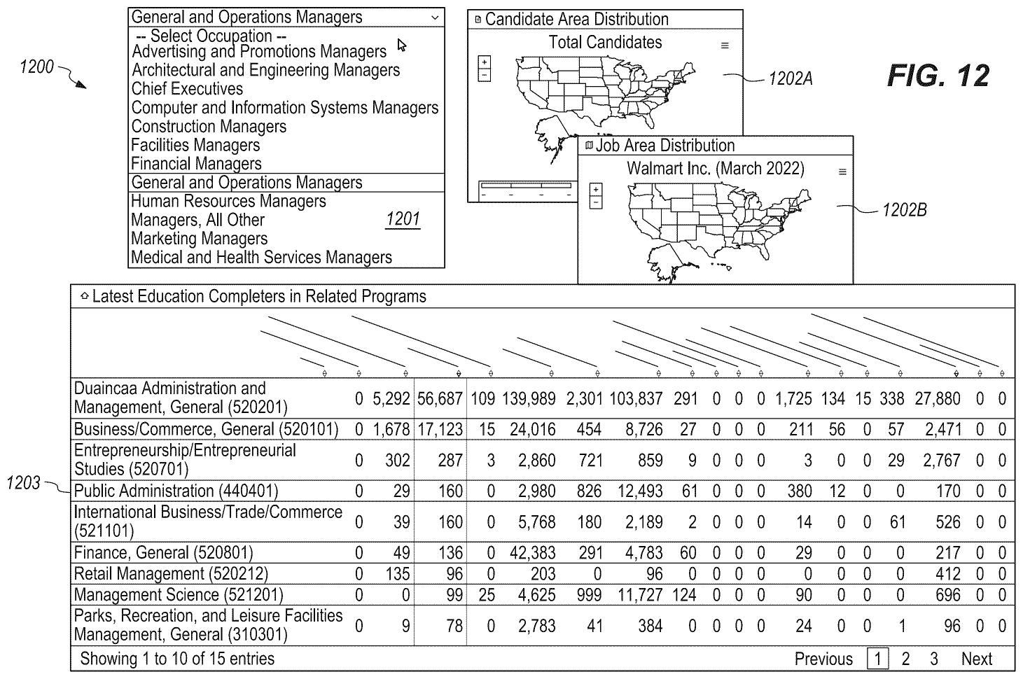

Referring now to FIG. 12, there is shown an example of a screen 1200 for graphically displaying candidate distribution and education graduates, according to one embodiment. User 100 can select an occupation from menu 1200. Candidate area distribution 1202A and/or job area distribution 1202B for the selected occupation may then be graphically depicted on a map of the country. At the bottom is a list 1203 of numbers of latest education completers in programs related to the selected occupation.

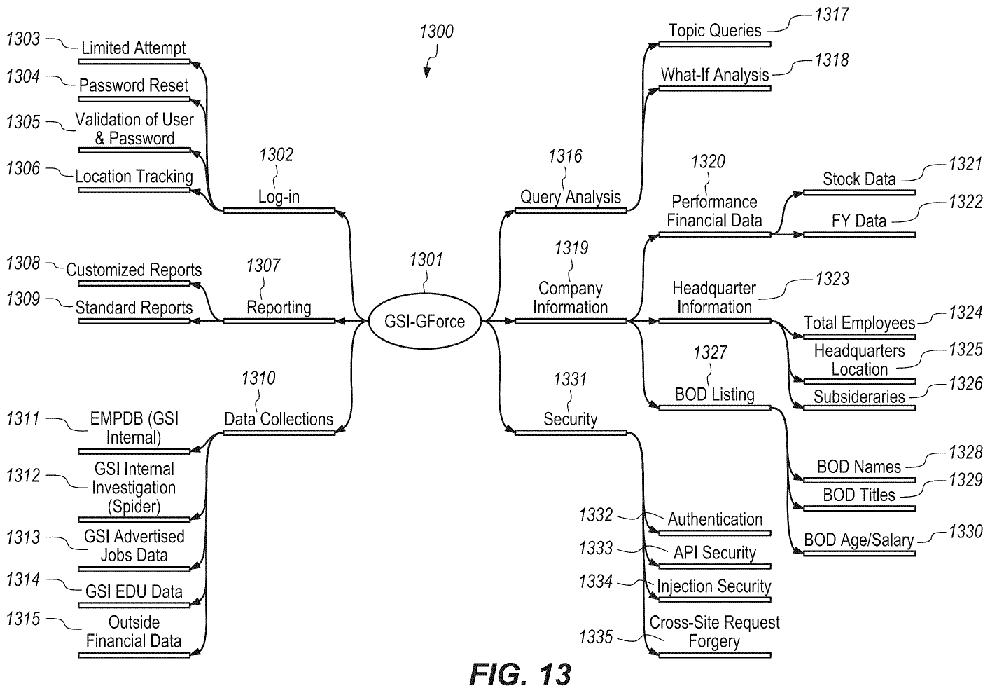

Referring now to FIG. 13, there is shown an example of an overview 1300 of process steps for implementing the various techniques and functionality described herein, as follows:
Login section 1302 may provide access to functionality for location tracking 1306, validation of user ID and password 1305, password reset 1304, and limited attempt tracking 1303;
Reporting section 1307 may provide access to customized reports 1308 and standard reports 1309;
Data collections section 1310 may provide access to functionality for EMPD B 1311, internal investigations 1312, advertised job data 1313, EDU data 1314, and/or outside financial data 1315;
Query analysis section 1316 may provide access to functionality for topic queries 1317 and/or what-if analysis 1318;
Company information section 1319 may provide access to performance financial data 1320 (including stock data 1321 and/or fiscal year data 1322), headquarters information 1323 (including total employees 1324, headquarters location 1325, and/or subsidiaries 1326), and board of directors listing 1327 (including names 1328, titles 1329, ages, and/or salaries 1330); and
Security section 1331 may provide access to functionality for authentication 1332, API security 1333, injection security 1334, and/or cross-site request forgery detection 1335.

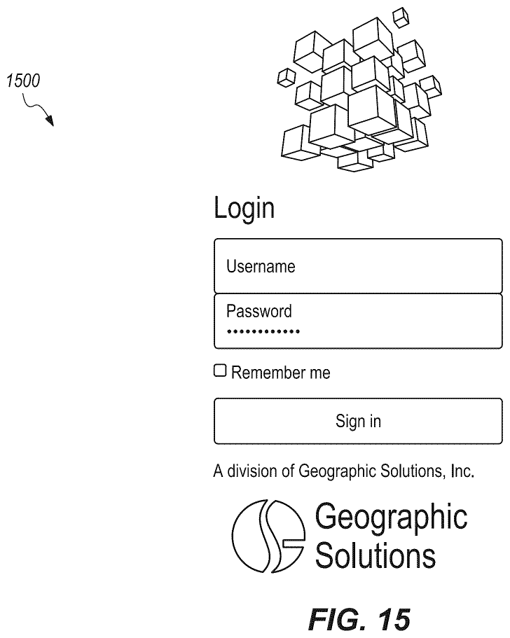

Referring now to FIG. 15, there is shown an example of a login screen 1500. Once the client module has received user's 100 login credentials, a simple username and password may be needed to access the system. After three unsuccessful tries of logging in, user 100 may be required to change their password. This may be an automated process. In at least one embodiment, the system does not store passwords for clients. A generic password may be given out to a client, and they may be required to create a new password. The system may have 256-bit encryption, with SOC II, type II certification. The system may also have the ability to ask for a two-factor authorization process, wherein it may utilize third-party authorization tools to accomplish this.

### Sidebar

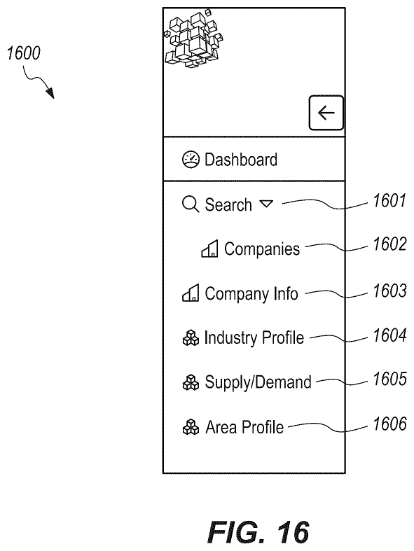

Referring now to FIG. 16, there is shown an example of a sidebar that may be present on all screens in the system. The left-facing arrow, when selected, may collapse the options; user 100 may then expand the options by clicking on a right-facing arrow. Sidebar may include the following, for example:
Search 1601: a collapsible option that may include any number of selectable search options. One example is Companies 1602, which activates a search for companies.
Company Info 1603: may allow user 100 to bring up company information after a company has been selected and appears on their dashboard
Industry Profile 1604.
Supply/Demand 1605.
Area Information 1606: may allow user 100 to elect fields they wish to report on.

### Search/Companies

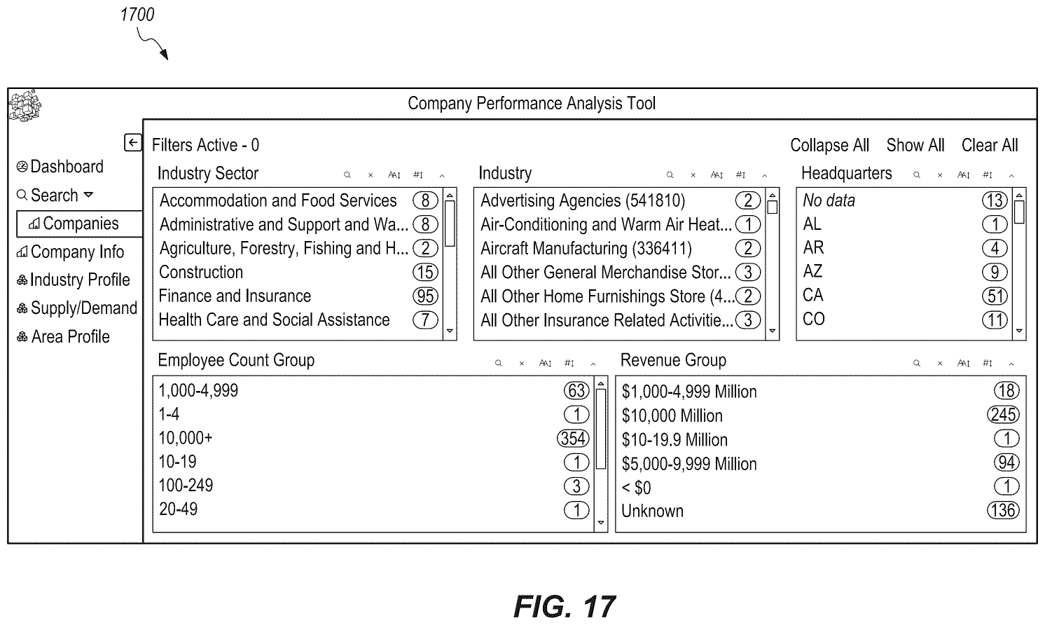

Referring now to FIG. 17, there is shown an example of a Search/Companies screen 1700, which may be a starting point for user 100 to start searching for the company they are seeking without knowing the company name. There are several ways to search for a company. FIG. 17 depicts the starting point.

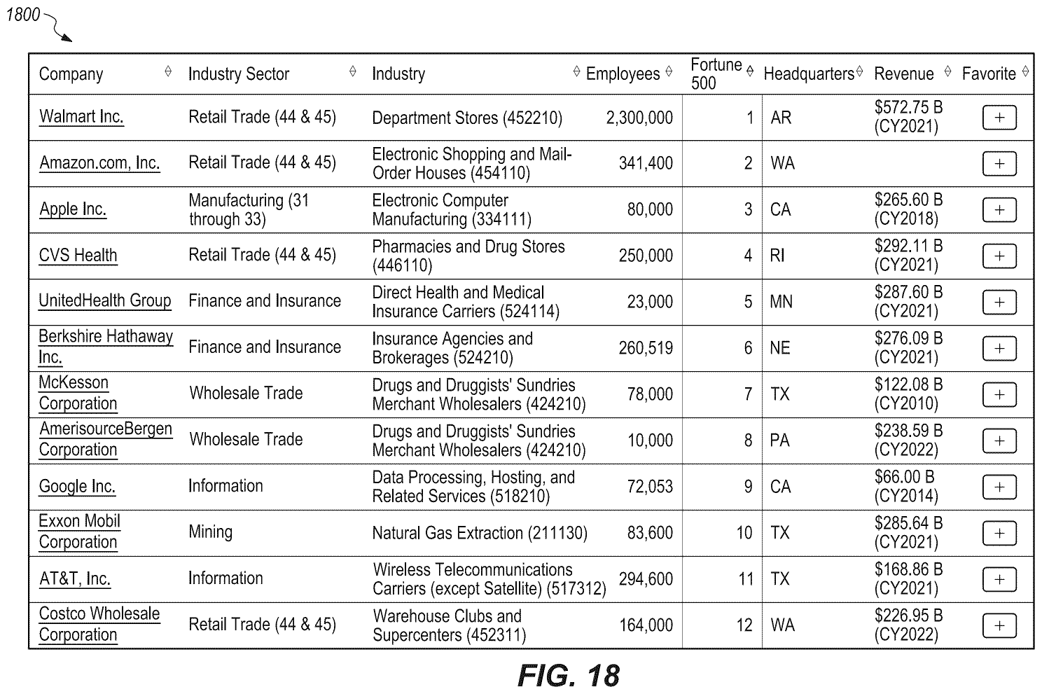

Referring now to FIG. 18, there is shown an example of a display of search results 1800 including companies that meet the search criteria. For example, if user 100 searches for Construction, list 1800 only shows construction companies. In at least one embodiment, list 1800 can further be defined and narrowed by using the Industry search along with the Industry Sector.

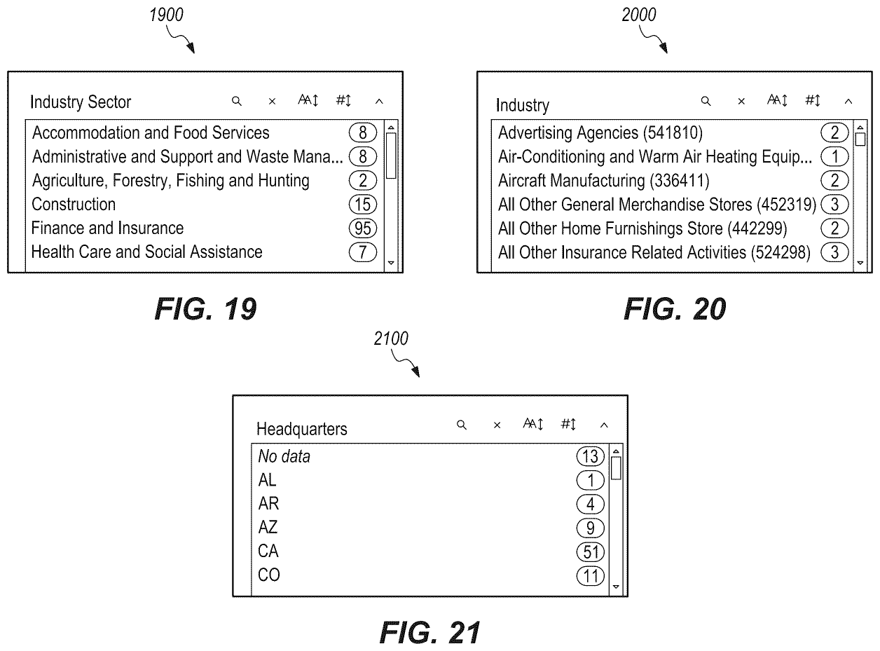

Referring now to FIG. 19, there is shown an example of an Industry Sector screen 1900 that lists industries by their NAICS (North American Industry Classification System) code. This code is self-assigned by businesses to identify a particular type or category of business. Next to the Industry Sector is the total number of companies that the system has stored that are related to the Industry. This number may increase or decrease based on the population of companies within the system.

Referring now to FIG. 20, there is shown an example of an Industry Search screen 2000 that may be a further definition of the Industry Sector. For example, Construction can be broken down further by Commercial Construction, Residential Construction, etc. Screen 2000 may allow user 100 to go further into the search by minimizing the search criteria in case the Industry Sector pulls too many companies for user 100 to search through. The corresponding number identifies the number of companies that meet the Industry Sector and Industry, thus further narrowing the list of companies to present.

Referring now to FIG. 21, there is shown an example of a Headquarters Search screen 2100 that tells user 100 for the selected Industry Sector and Industry, the state their headquarters are in, and how many are listed for that state. Any of these search boxes can be used in any order user 100 wishes. These numbers may be automatically adjusted based on how many companies the system has in its databases.

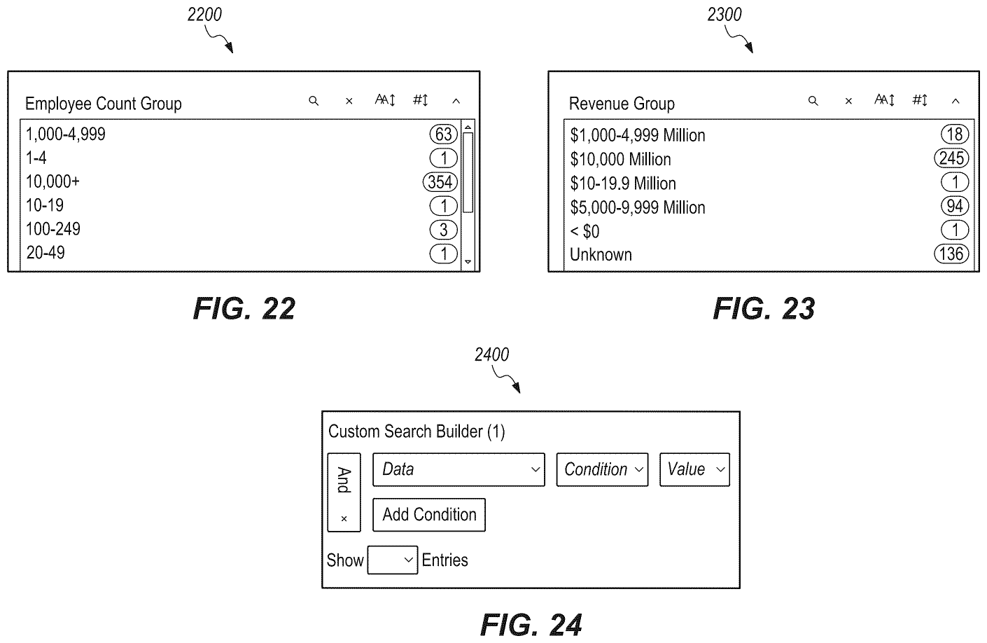

Referring now to FIG. 22, there is shown an example of an Employee Count Group screen 2200 that provides another searchable criterion that user 100 can use to further define the company they are searching for. The same information pattern is shown for Employee Count Group. The number on the right represents how many companies are within the Employee Count Group. This can be used independently, or in conjunction with the other search boxes.

Referring now to FIG. 23, there is shown an example of a Revenue Group screen 2300 that provides yet another way user 100 can search for a company, i.e., by their revenue. For example, user 100 may only want to see companies that have annual revenues between $1 M and $5 M. These revenues may be determined by latest SEC filings.

In at least one embodiment, a Board of Directors Group screen may be provided, which may allow user 100 to search for companies by the name of a Board Member. The system may take into account the fact that many Board Members may serve on more than one company.

Referring now to FIG. 24, there is shown an example of a Custom Search Builder screen 2400, which may provide a free-form search as may be used by a more experienced user 100. Screen 2400 may allow user 100 to specify multiple search criteria contained within one area, and may display the results in the same manner as the above-referenced search criteria.

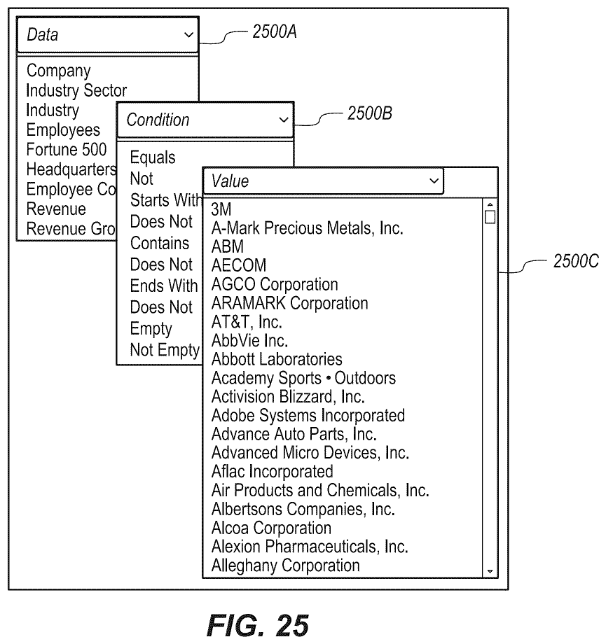

Referring now to FIG. 25, there are shown examples of Data/Condition/Value drop-down lists 2500A, 2500B, 2500C that contain all the search criteria as mentioned above. User 100 can select any of the information in drop-down lists 2500A, 2500B, 2500C, in any desired combination, to create a customized search.

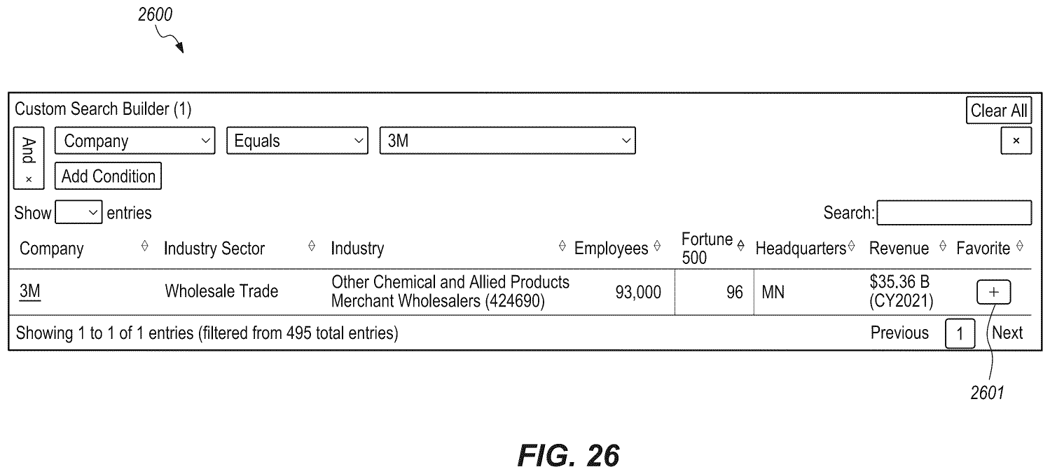

Referring now to FIG. 26, there is shown an example of a display of results 2600 that may be presented to user 100. It may show the Company name, Industry Sector, Industry, the Number of Employees, Company Ranking, their headquarters and Revenue. Plus sign 2601 may be provided, which, when activated, may cause the company and its query to be added to the dashboard.

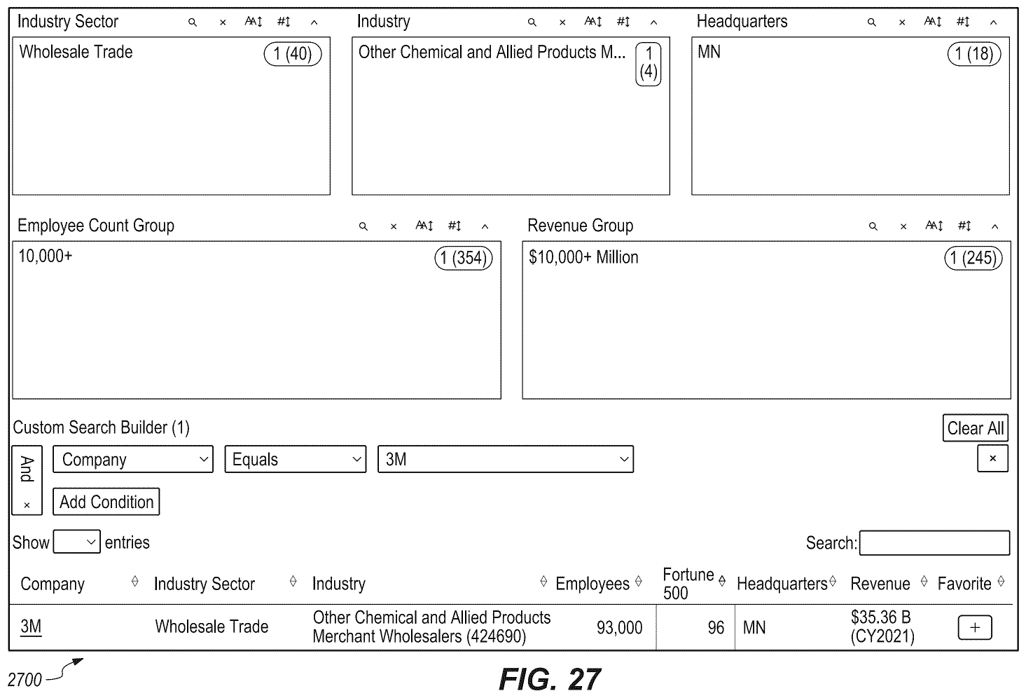

Referring now to FIG. 27, there is shown an example of the entire search screen 2700, including the various components described above, according to one embodiment.

### Dashboard

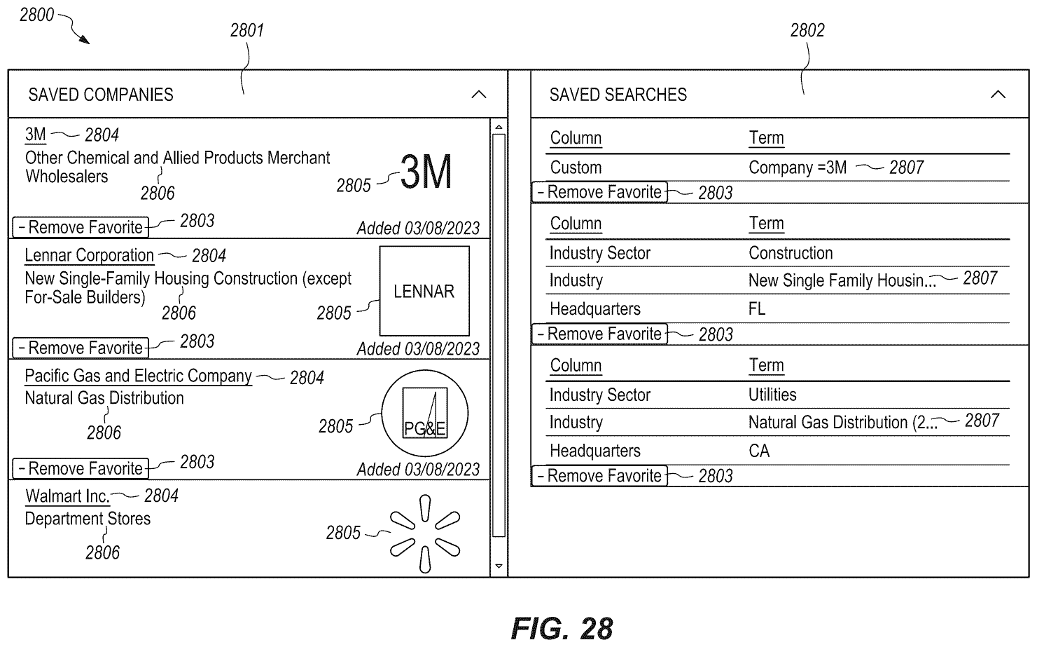

Referring now to FIG. 28, there is shown an example of a dashboard 2800 that may be activated when user 100 selects plus sign 2601 on search results 2600 as described above in connection with FIG. 26. Using the techniques of the described system, user 100 can save any number of companies and/or searches. As shown in the example of FIG. 28, dashboard 2800 may include saved companies 2801 and/or saved searches 2802.

For each saved company, a company name 2804, logo 2805, and main category of industry 2806 may be displayed. For each saved search, the corresponding search criteria 2807 may be displayed. A remove button 2803 may be provided for each saved company and saved search, to delete the entry from the display.

In at least one embodiment, each user 100 may have their own dashboard 2800, as the system may save user input.

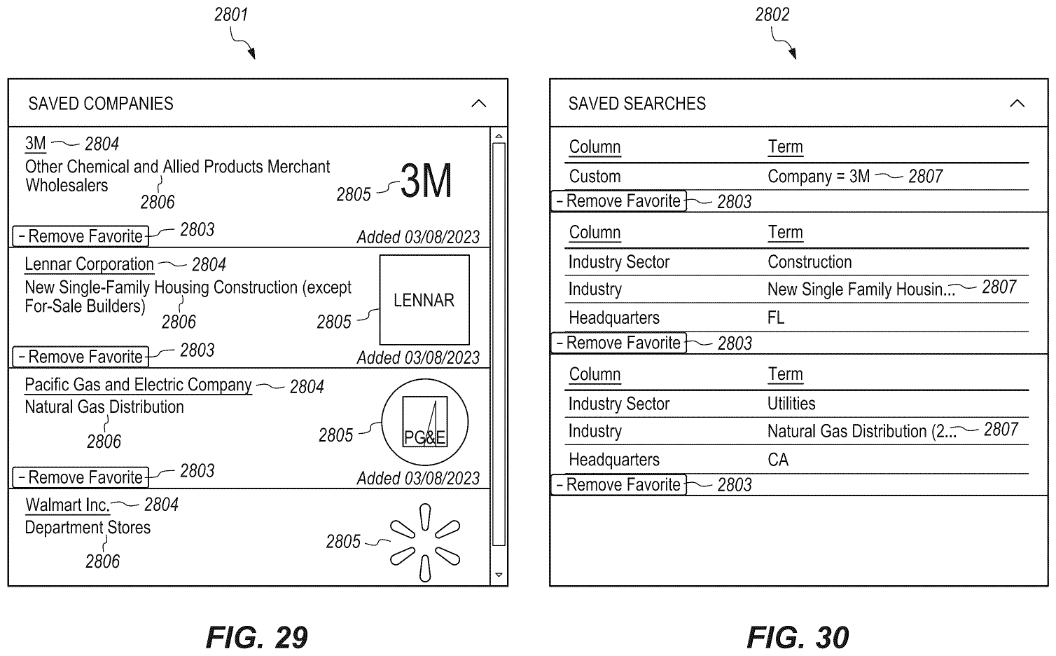

Referring now to FIG. 29, there is shown an example of display of saved companies 2801.

Referring now to FIG. 30, there is shown an example of display of saved searches 2802.

### Company Information

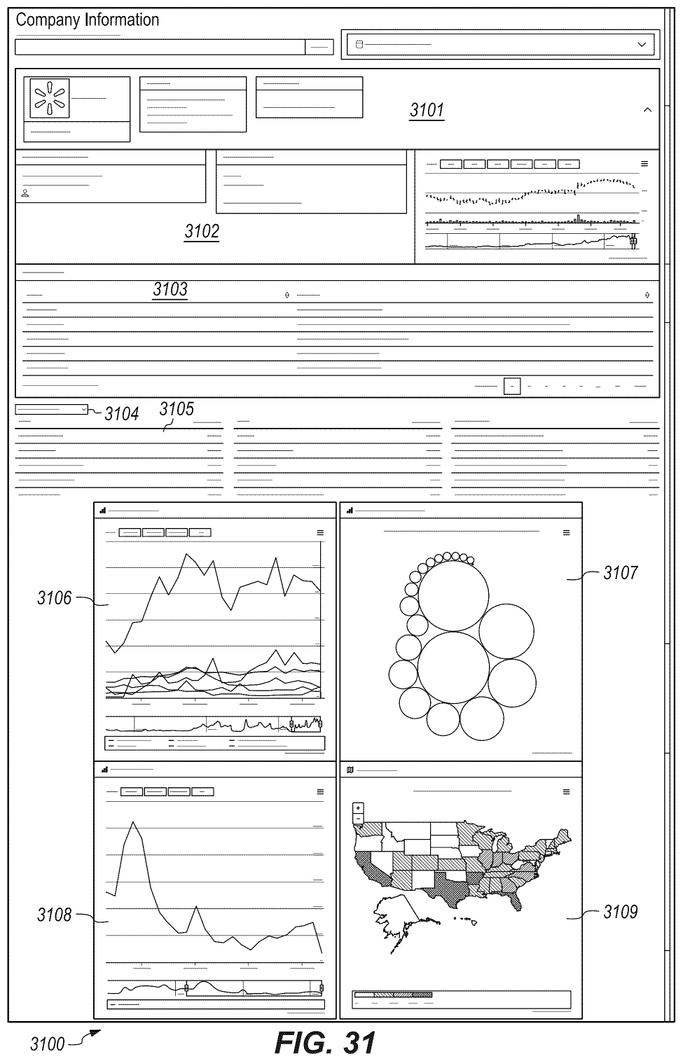

Referring now to FIG. 31, there is shown an example of a Company Information screen 3100 that may include several sections, including for example:
Basic Company Information 3101
Headquarters, Stock Ticker, Stock Price, and Stock Analysis 3102
Key Executives 3103
Time Frame Selector 3104
Skill/Tool/Certifications 3105
Job Market Data, including for example
   Historic Job Counts 3106
   Active Jobs by SOC Group 3107
   Monthly Applies 3108
   Job Distribution 3109

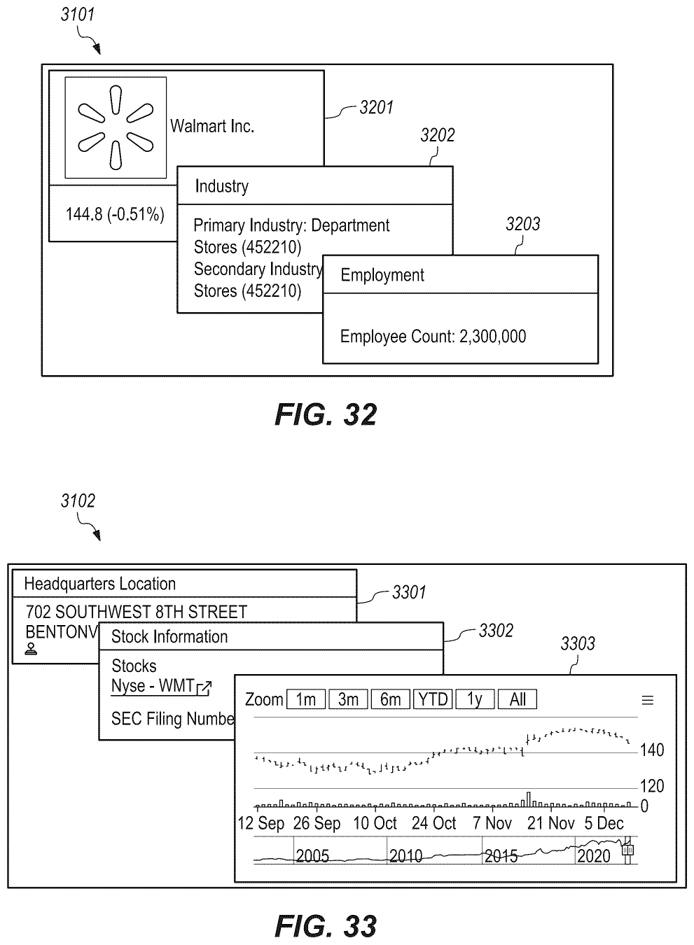

Various sections of screen 3100 are described in connection with FIGS. 32 to 41.

Referring now to FIG. 32, there is shown an example of Basic Company Information 3101 section of Company Information screen 3100, including window 3201 including company name and stock ticker. A link may be provided to a finance website such as Yahoo Finance, which provides current stock pricing. Industry window 3202 displays the Industry NAICS Code along with a secondary Industry. The Employment window indicates the company's employee count, based on the most recent available information.

Referring now to FIG. 33, there is shown an example of Headquarters information section 3102 of Company Information screen 3100, including Headquarters location 3301, stock information 3302, and historical stock information 3303 over a time period, such as for example one month through one year.

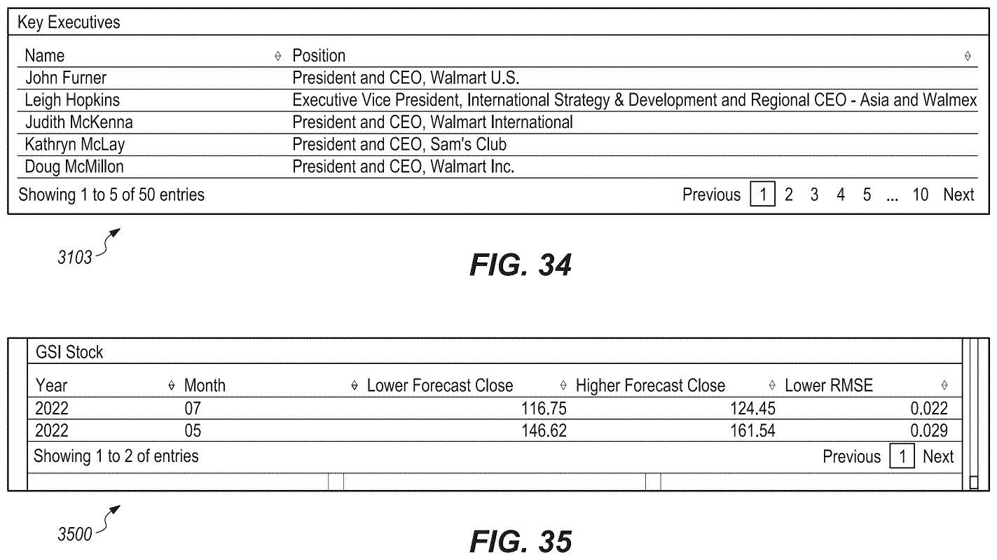

Referring now to FIG. 34, there is shown an example of Key Executives information section 3103 of Company Information screen 3100. This information may be of importance when user 100 is searching for outcomes based on Key Executives.

Referring now to FIG. 35, there is shown an example of Stock Analysis section 3500 that may be included in Company Information screen 3100. In at least one embodiment, Stock Analysis section 3500 may include stock valuation that may be performed, for example, by determining the lowest stock price and highest stock price based on historical stock data. This information may be used as a decision tool to determine valuation. The buy and sell target prices may represent optimal prices that an investor should buy and then sell certain stocks over a two-month period. These recommendations may be based on probabilities of stock prices going below their forecasted lows in month 1 and above their forecasted highs in month 2.

In at least one embodiment, the forecasts depicted in Stock Analysis section 3500 may utilize monthly job openings and job postings by each company as well as some publicly available data like U.S. T-Bill yields. The pool of equities that are forecasted may be derived from any suitable source, such as the Fortune 500. In at least one embodiment, the system capitalizes on month-to-month volatility in price to give a better average return than an investor would have in holding their funds in a market index or large cap ETF.

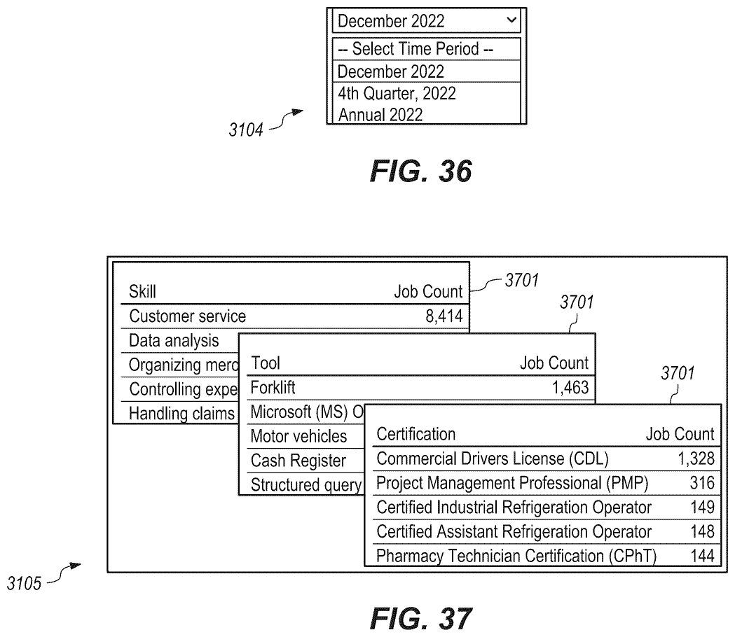

Referring now to FIG. 36, there is shown an example of a Time Frame dropdown menu 3104 that may allow user 100 to select a timeframe to be used for various screens of information. In at least one embodiment, the default is the most recent month of information loaded into the system.

Referring now to FIG. 37, there is shown an example of a portion of the example of FIG. 31, including an example of a display of Skill/Tool/Certifications 3105. Within each category, each window 3701 may display the top five Skill, Tool, and Certifications that are required by the selected company.

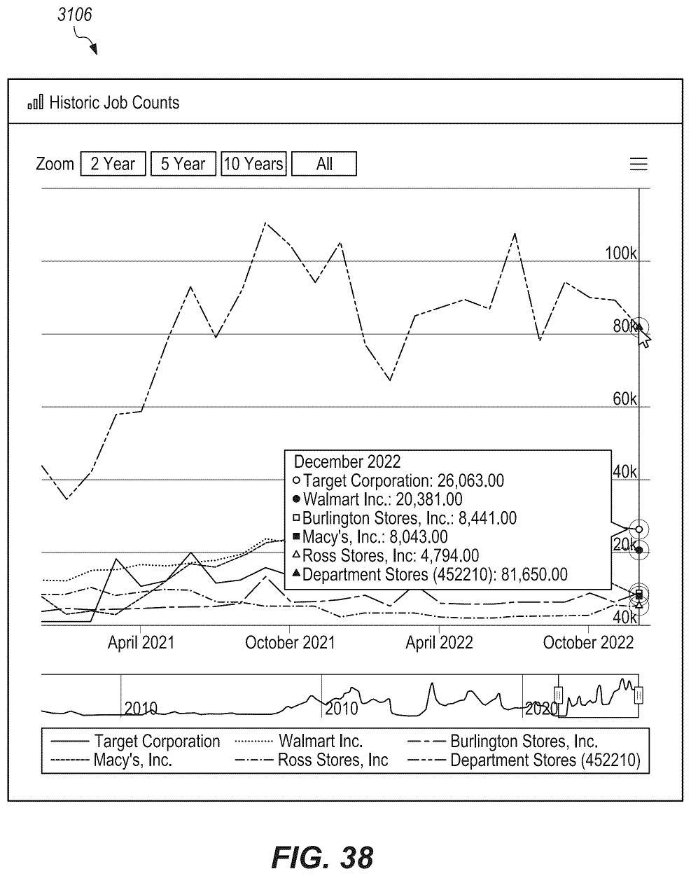

FIG. 38 depicts a portion of the example of FIG. 31, including an example of a display of Historic Job Counts 3106. In the example, multiple items may be shown on a single line graph 3801. For the selected company, the system may take the top five competitors for that NAICS group, and may present a chart or graph of all five competitors including overall job counts. Each company can be selected and deselected with a range, for example, from two years to ten years of data.

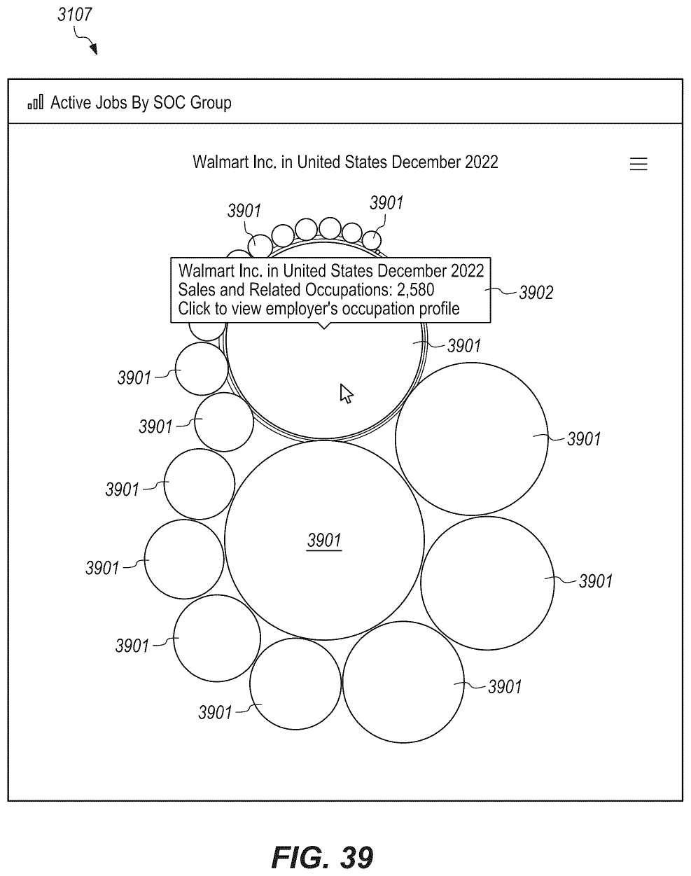

Referring now to FIG. 39, there is shown an example of a portion of the example of FIG. 31, including an example of a display of Active Jobs By SOC Group 3107. In at least one embodiment, display 3107 may be an interactive bubble graph containing any number of bubbles 3901. When user 100 moves the cursor to hover over a bubble 3901, the display may show a pane 3902 listing information about the company, such as the Occupation and the count of jobs. In at least one embodiment, when an item is selected, an additional screen may be presented to drill down on the selected bubble 3901.

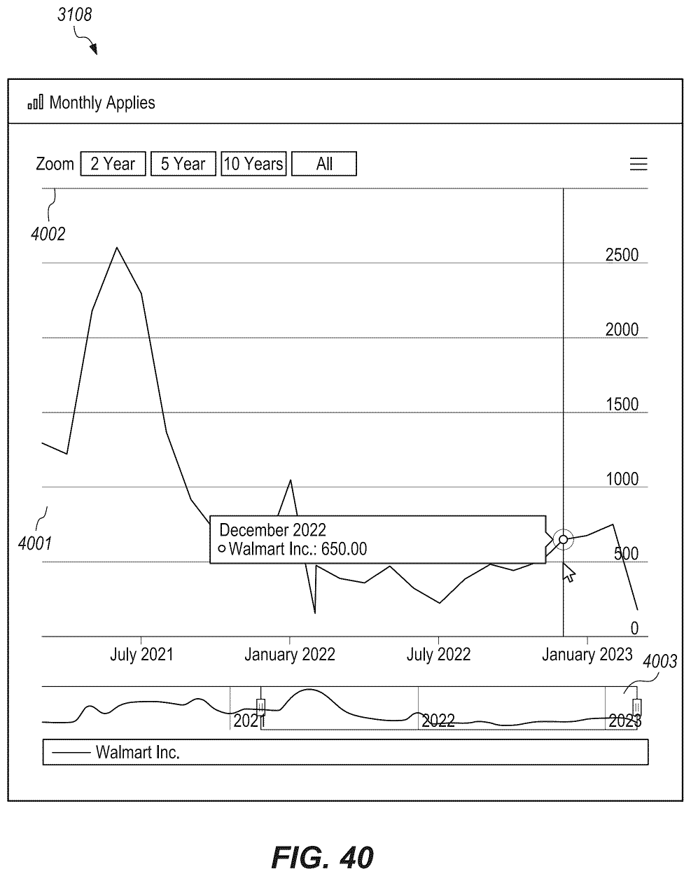

Referring now to FIG. 40, there is shown an example of a portion of FIG. 31, including an example of a display of Monthly Applies 3108, including line graph 4001. Based on the SOC group selected in the previous screen, some subset of occupations (such as the top five) may be presented for the time period selected. In the depicted example, user 100 can select which occupations to display. By selecting a “+” or “−” sign, user 100 can add or delete items from line graph 4001.

In at least one embodiment, line graph 4001 of Monthly Applies may indicate how many potential candidates have applied for an open job position. Zoom level control 4002 allows user 100 to specify the span of line graph 4001, for example from two years to ten years or more. Interactive slide bar 4003 may be used to specify the amount of data to show based on time.

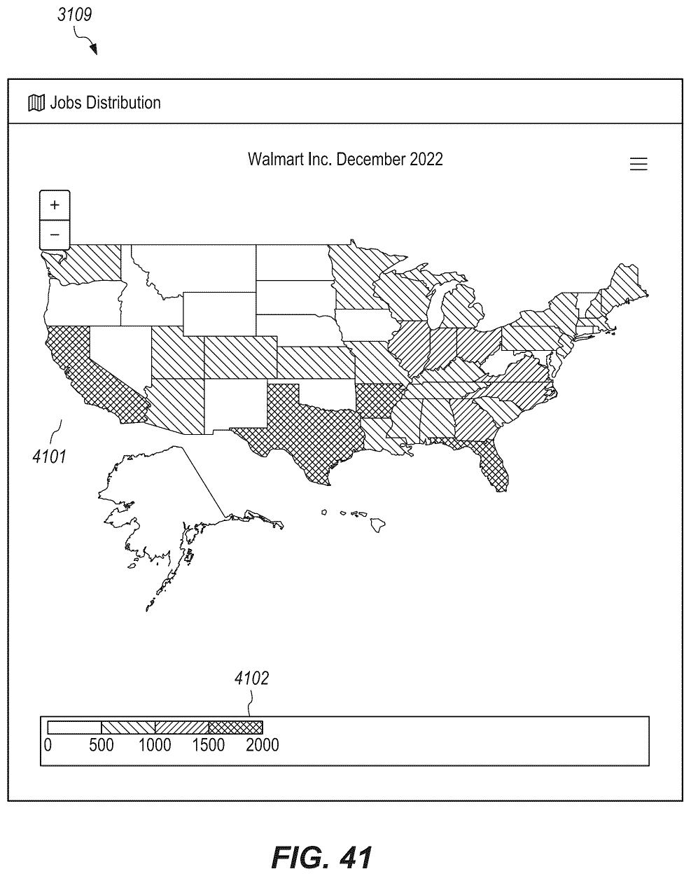

Referring now to FIG. 41, there is shown an example of a country Job Distribution display 3109, including a map 4101 of the United States that may be color-coded to indicate the number of jobs physically located within each state. The darker the color, the more jobs are in that state, as indicated by legend 4102. User 100 can hover over a state to cause the system to display the number of jobs located in that state for the time period selected from time display drop-down menu 3104 of FIG. 31.

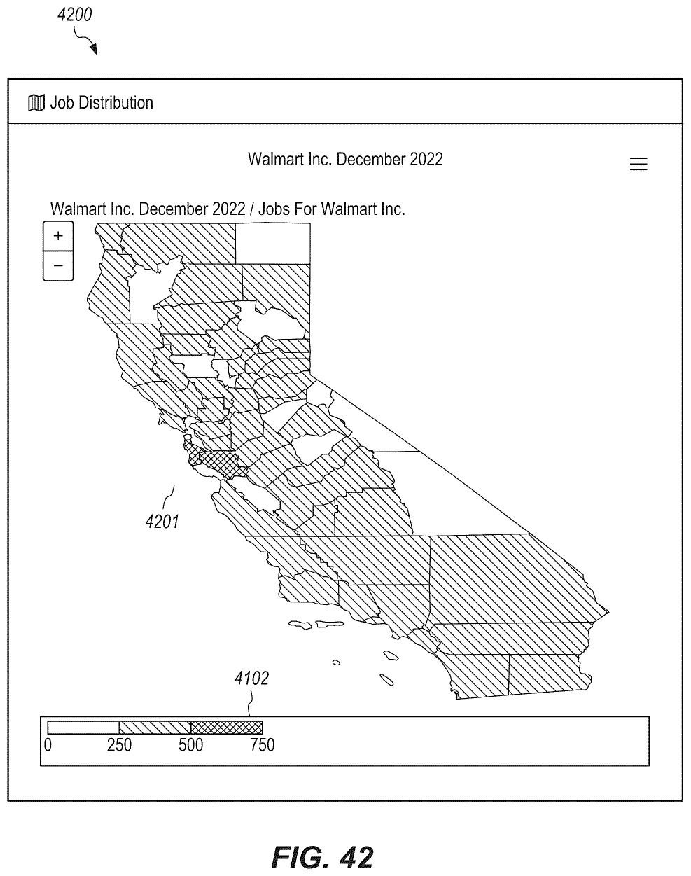

Referring now to FIG. 42, there is shown an example of a state Job Distribution display 4200, including a map 4201 of a state (in this case, California). User may select a state from a suitable on-screen display, causing map 4201 to change to display counties within the selected state. The same color-coding is displayed as described above and indicated by legend 4102: The darker the color, the more jobs are in that county.

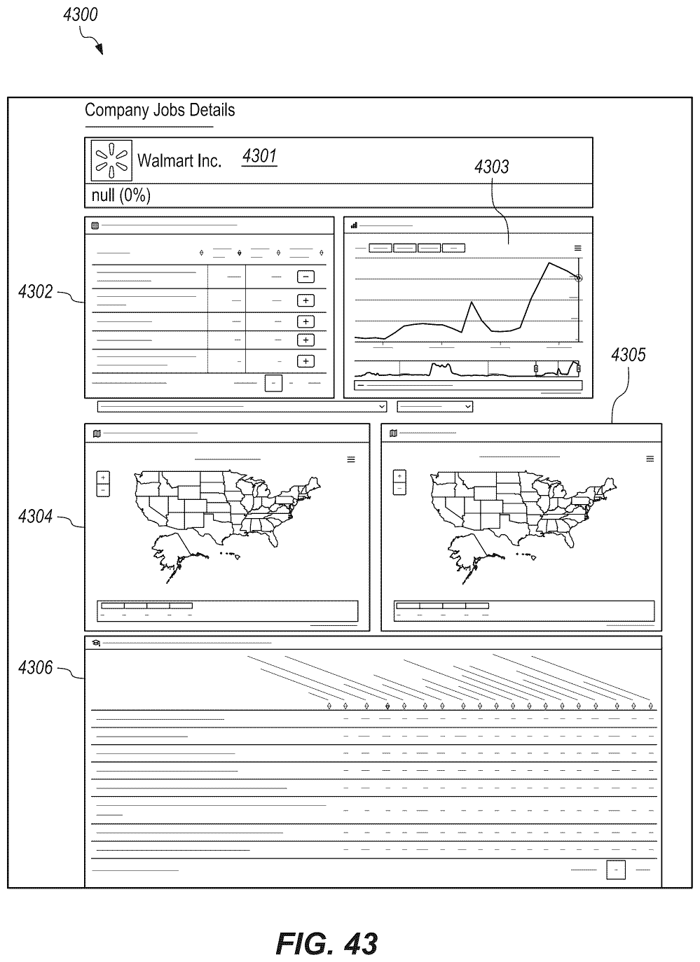

Referring now to FIG. 43, there is shown an example of a Company Jobs Detail screen 4300, which may be presented as a continuation of the example of FIG. 31. As shown in the example, Company Jobs Detail screen may include:
Company Name and/or Stock Ticker 4301
Detailed Occupations for Selected SOC group 4302
Historic Job Counts 4303
Candidate Area Distribution 4304
Job Area Distribution 4305
Education Completers in Related Programs for Selected SOC Group 4306

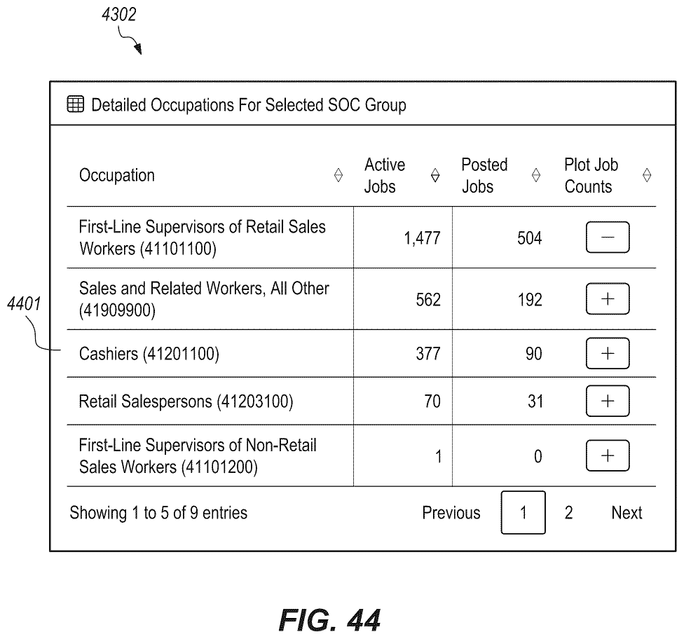

Various sections of screen 4300 are described in connection with FIGS. 44 to 46.

Referring now to FIG. 44, there is shown an example of Detailed Occupations By Selected SOC Group section 4302 of FIG. 43. For a selected SOC group, some number of occupations (such as the top five) may be displayed in table 4401. There may be multiple job definitions for a particular SOC code, as shown within the displayed window.

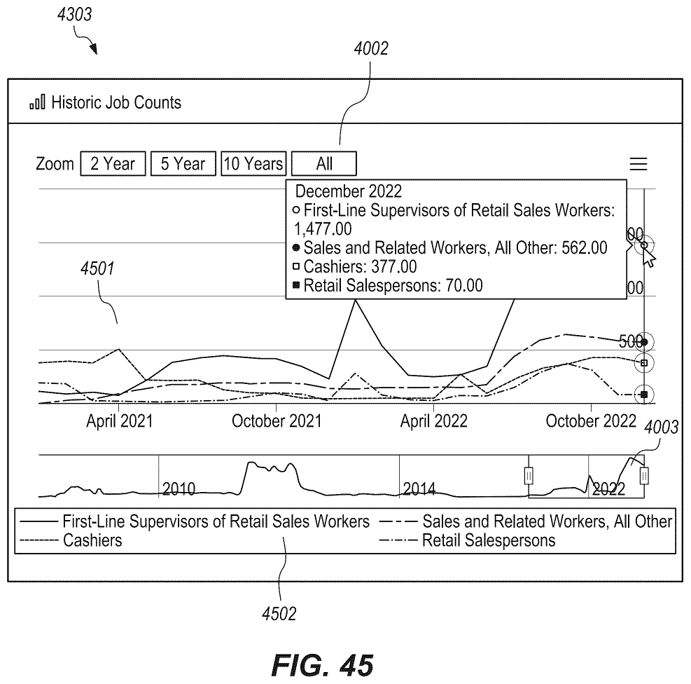

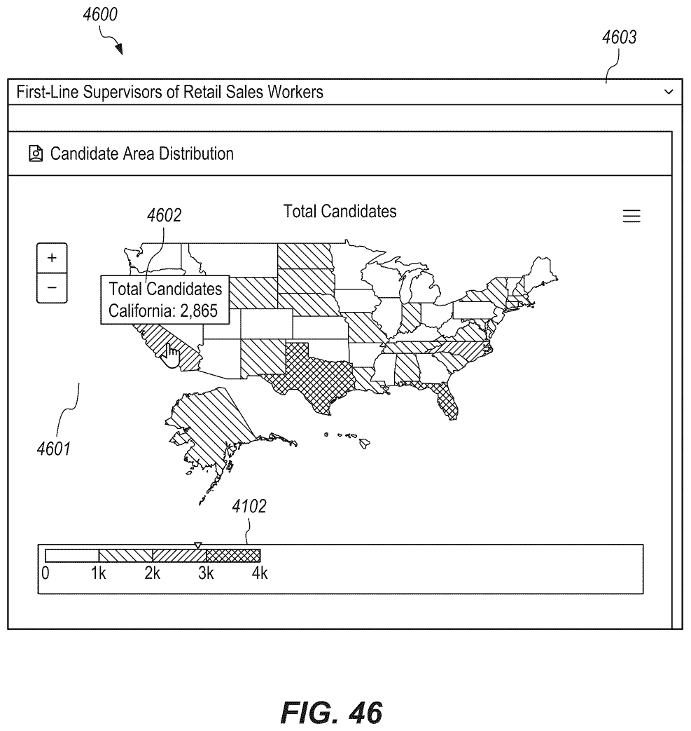

Referring now to FIG. 45, there is shown an example of Historic Job Counts section 4303 of FIG. 43, including visual display 4501 of those jobs depicted in FIG. 44, over a selected time period as specified in Zoom level control 4002. Interactive slide bar 4003 may be used to specify the amount of data to show based on time. In at least one embodiment, user 100 can remove any of the displayed lines, for example by deselecting the Occupation in table 4401 of FIG. 44, or by clicking on one of the job titles in interactive legend 4502.

Referring now to FIG. 46, there is shown an example of country Candidate Area Distribution section 4304 of FIG. 43, including visual display 4601 of the United States which may be color-coded to indicate the number of candidates (for a particular position) that are located within each state. The darker the color, the more candidates are in that state, as indicated by legend 4102. User 100 can hover over a state to cause the system to display pane 4602, including the number of candidates located in that state that meet the requirements for the position selected in menu 4702 (in this case, First Line Supervisors of Retail Sales).

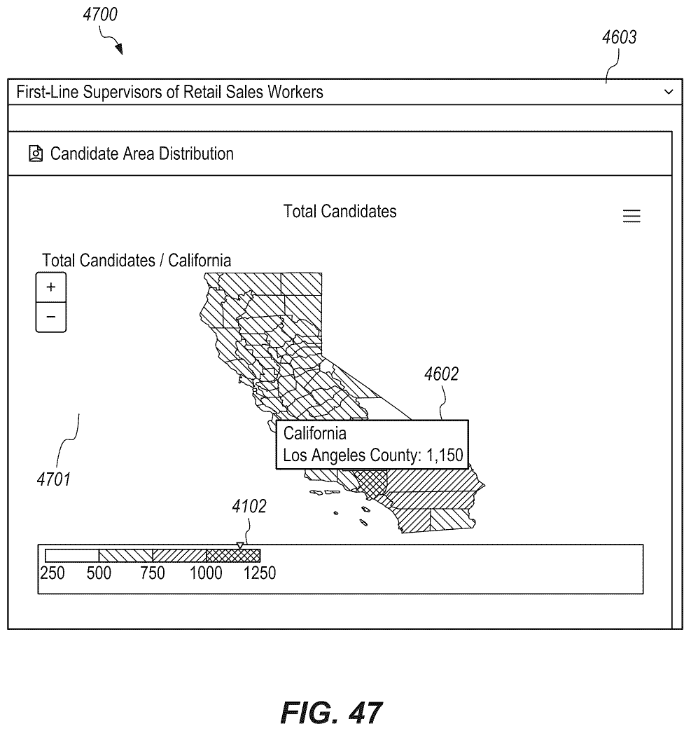

Referring now to FIG. 47, there is shown an example of a state Candidate Area Distribution display 4700, including a map 4701 of a state (in this case, California). In at least one embodiment, user 100 may select any desired state, causing the map to change to display counties within the selected state. The same color-coding is displayed as described above: The darker the color, the more candidates (for a particular position) are in that county, as indicated by legend 4102. User 100 can hover over a county to cause the system to display pane 4602, including the number of candidates located in that county that qualify or have expressed the desire to be a candidate for the position selected in menu 4702 (in this case, First Line Supervisors of Retail Sales).

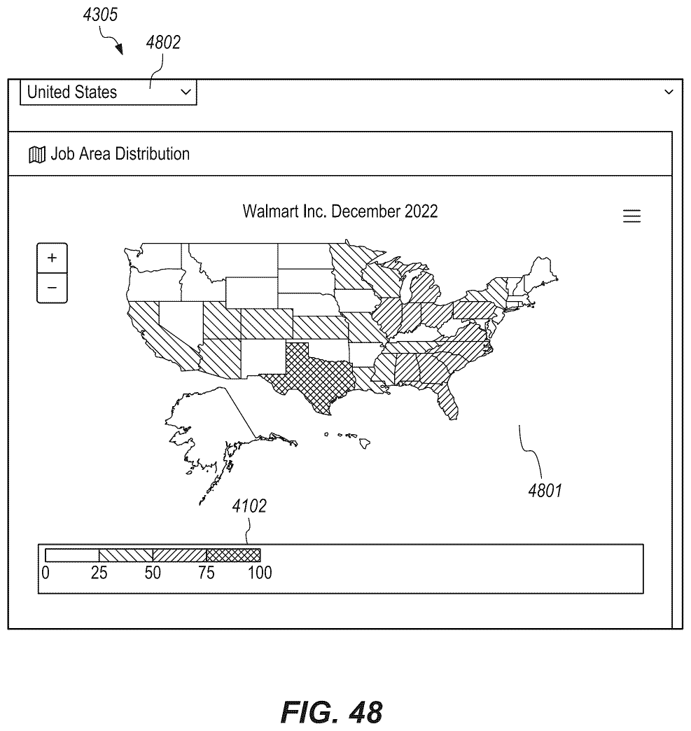

Referring now to FIG. 48, there is shown an example of Job Area Distribution section 4305 of FIG. 43, including visual display 4801 of the United States, which may be color-coded to indicate where jobs are being offered for the selected SOC group. The darker the color, the more job offers exist in that state, as indicated by legend 4102. In at least one embodiment, user 100 can select a state by clicking on it within display 4801 or by selecting it from menu 4802.

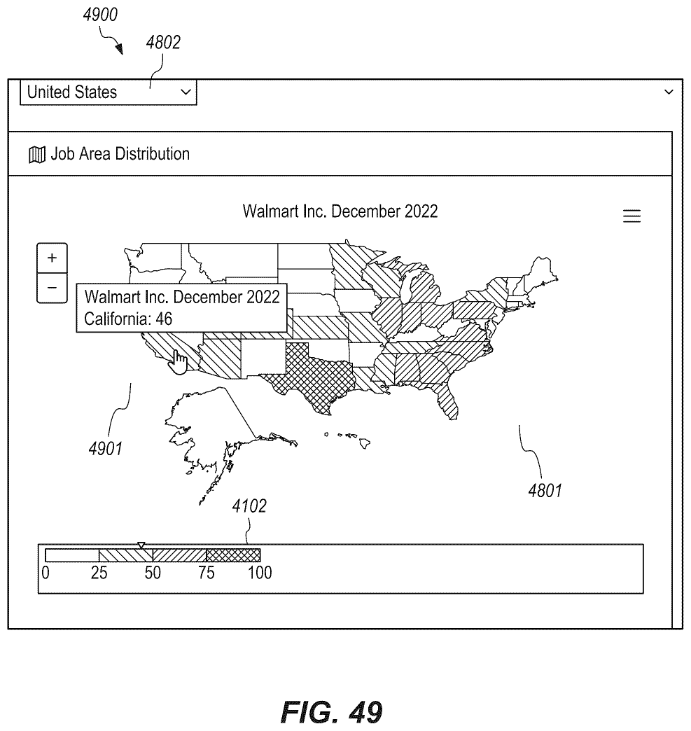

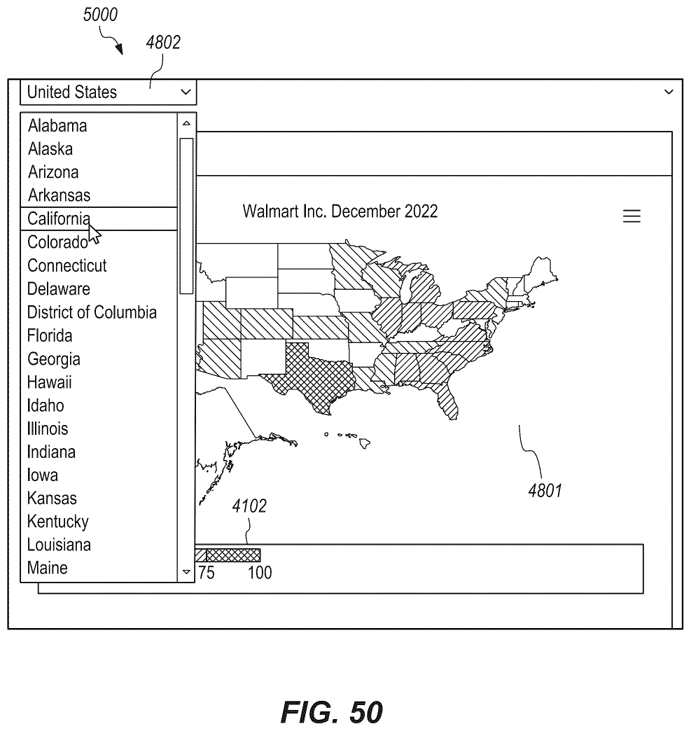

Referring now also to FIG. 49, there is shown an example 4900 of user selection of a state by clicking on it (using cursor 4901). Referring now also to FIG. 50, there is shown an example 5000 of user selection of a state by selection from menu 4802.

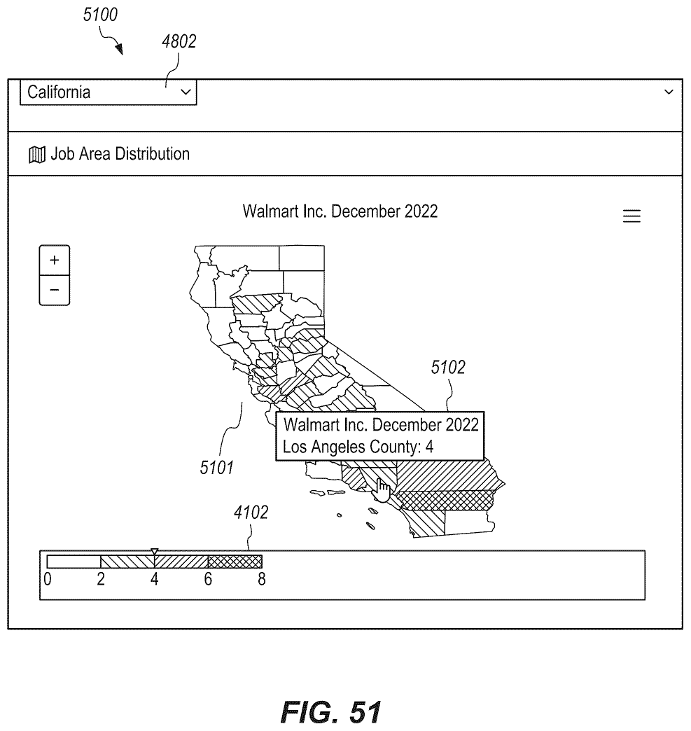

Referring now to FIG. 51, there is shown an example of state Job Distribution display 5100. When a state is selected (either by clicking on the state in visual display 4801 of the United States or by selection from menu 4802), a map 5101 displaying counties within that state may be shown. The same color-coding is displayed: The darker the color, the more jobs are available within that county, as indicated by legend 4102. User 100 can cause the cursor to hover over a county to cause pane 5102 to be displayed, showing jobs of the specified type for that county. In the depicted example, there are four advertised jobs for First-Line Supervisors in Los Angeles County, California.

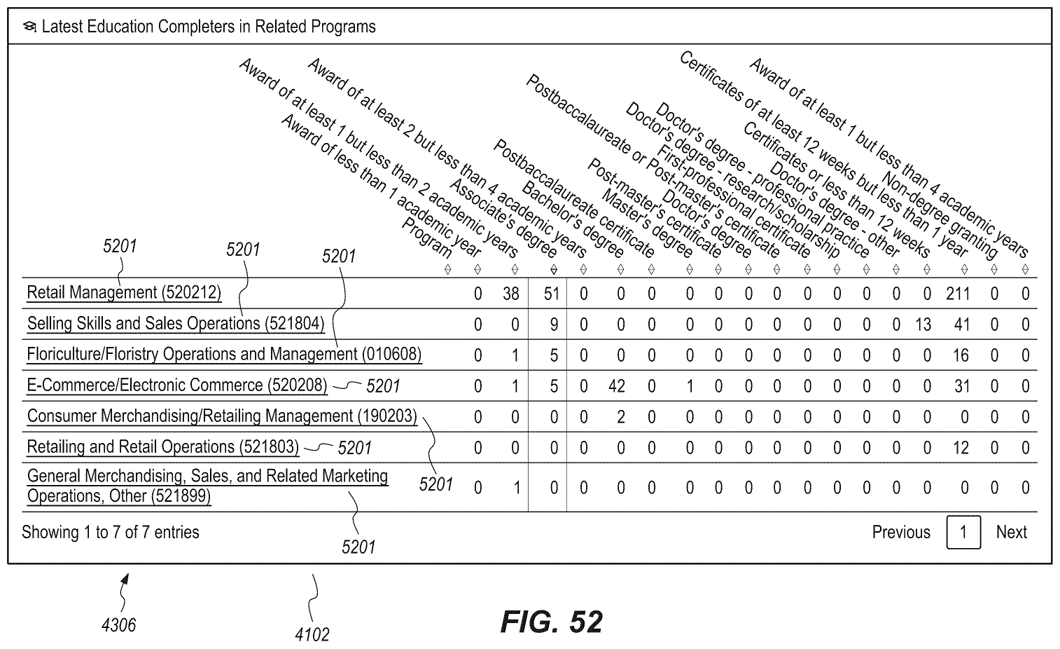

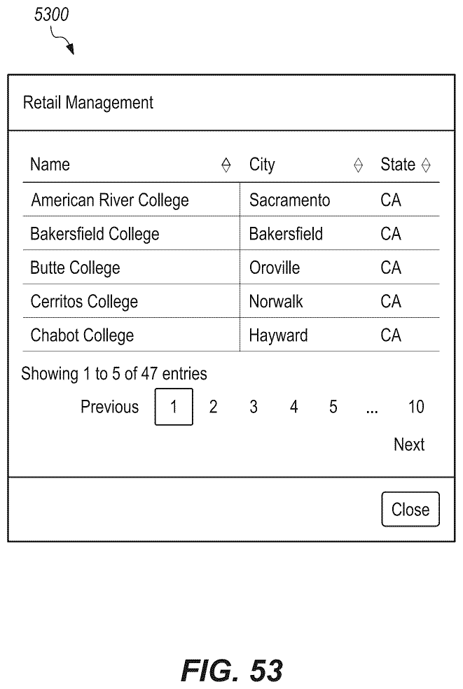

Referring now to FIG. 52, there is shown an example of table 4306 from FIG. 43, indicating Education Completers in Related Programs for the Selected SOC Group. Table 4306 may indicate how many job candidates are in the selected state, and the certificates and/or degrees that they have. User 100 can select any highlighted links 5201 to cause display 5300 of schools for the completers to be shown, as depicted in the example of FIG. 53. In at least one embodiment, display 5300 may include a listing of each school's name, city and state. If desired, the display can be sorted alphabetically by name, city, and/or or state.

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. In addition, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It may be convenient at times, principally for reasons of common usage, to refer to these signals as bits, values, elements, symbols, characters, terms, numbers, or the like. Furthermore, it may also be convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it may be appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions may be embodied in software, firmware and/or hardware, and when embodied in software, may be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMS, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device may include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the described system and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Washington; MacOS, available from Apple Inc. of Cupertino, California; iOS, available from Apple Inc. of Cupertino, California; Android, available from Google, Inc. of Mountain View, California; and/or any other operating system that may be adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A computer-implemented method for performing predictive analysis based on aggregated data, comprising:
at a processor, automatically collecting data associated with an entity from a plurality of geographically diverse sources;
at the processor, automatically aggregating the collected data;
at a storage device, storing the aggregated data;
at the processor, generating, from the aggregated data, an interactive analytical report depicting a geographic distribution of at least one quantitative data element associated with the entity; and
at an output device, displaying the generated report.

2. The method of claim 1, wherein the entity comprises a corporation.

3. The method of claim 2, wherein the geographic distribution of at least one quantitative data element associated with the entity comprises a geographic distribution of job listings associated with the corporation.

4. The method of claim 2, wherein the interactive analytical report further depicts corporate data describing the corporation.

5. The method of claim 4, wherein the corporate data describes at least one selected from the group consisting of:
financial data;
stock data;
corporate valuation;
board of directors;
headquarters;
competitors;
locations of schools from which the corporation is hiring;
job postings associated with the company; and
job skills the company is currently seeking.

6. The method of claim 4, wherein the corporate data describes at least one selected from the group consisting of:
financial data;
stock data;

7. The method of claim 2, wherein the interactive analytical report further depicts historical job information associated with the corporation.

8. The method of claim 1, further comprising:
causing an input device to receive user input specifying report parameters;
and wherein generating the interactive analytical report comprises generating the interactive analytical report using the specified report parameters.

9. The method of claim 1, wherein the interactive analytical report comprises an interactive map-based report graphically depicting quantitative data for a plurality of regions on a geographic map.

10. The method of claim 9, further comprising:
causing an input device to receive user input specifying a level of granularity for the map; and
displaying the interactive map-based report at the specified level of granularity.

11. A non-transitory computer-readable medium for performing predictive analysis based on aggregated data, comprising instructions stored thereon, that when performed by one or more hardware processing devices, perform the steps of:
automatically collecting data associated with an entity from a plurality of geographically diverse sources;
automatically aggregating the collected data;
causing a storage device to store the aggregated data;
generating, from the aggregated data, an interactive analytical report depicting a geographic distribution of at least one quantitative data element associated with the entity; and
at an output device, displaying the generated report.

12. The non-transitory computer-readable medium of claim 11, wherein the entity comprises a corporation.

13. The non-transitory computer-readable medium of claim 12, wherein the geographic distribution of at least one quantitative data element associated with the entity comprises a geographic distribution of job listings associated with the corporation.

14. The non-transitory computer-readable medium of claim 12, wherein the interactive analytical report further depicts corporate data describing the corporation.

15. The non-transitory computer-readable medium of claim 14, wherein the corporate data describes at least one selected from the group consisting of:
financial data;
stock data;
corporate valuation;
board of directors;
headquarters;
competitors;
locations of schools from which the corporation is hiring;
job postings associated with the company; and
job skills the company is currently seeking.

16. The non-transitory computer-readable medium of claim 14, wherein the corporate data describes at least one selected from the group consisting of:
financial data;
stock data;

17. The non-transitory computer-readable medium of claim 12, wherein the interactive analytical report further depicts historical job information associated with the corporation.

18. The non-transitory computer-readable medium of claim 11, further comprising:
at an input device, receiving user input specifying report parameters;
and wherein generating the interactive analytical report comprises generating the interactive analytical report using the specified report parameters.

19. The non-transitory computer-readable medium of claim 11, wherein the interactive analytical report comprises an interactive map-based report graphically depicting quantitative data for a plurality of regions on a geographic map.

20. The non-transitory computer-readable medium of claim 19, further comprising:
causing an input device to receive user input specifying a level of granularity for the map; and
causing the output device to display the interactive map-based report at the specified level of granularity.

21. A system for performing predictive analysis based on aggregated data, comprising:
a processor, configured to:
automatically collect data associated with an entity from a plurality of geographically diverse sources;
automatically aggregate the collected data; and
generate, from the aggregated data, an interactive analytical report depicting a geographic distribution of at least one quantitative data element associated with the entity;
a storage device, communicatively coupled to the processor, configured to store the aggregated data; and
an output device, communicatively coupled to the processor, configured to display the generated report.

22. The system of claim 21, wherein the entity comprises a corporation.

23. The system of claim 22, wherein the geographic distribution of at least one quantitative data element associated with the entity comprises a geographic distribution of job listings associated with the corporation.

24. The system of claim 22, wherein the interactive analytical report further depicts corporate data describing the corporation.

25. The system of claim 24, wherein the corporate data describes at least one selected from the group consisting of:
financial data;
stock data;
corporate valuation;
board of directors;
headquarters;
competitors;
locations of schools from which the corporation is hiring;
job postings associated with the company; and
job skills the company is currently seeking.

26. The system of claim 24, wherein the corporate data describes at least one selected from the group consisting of:
financial data;
stock data;

27. The system of claim 22, wherein the interactive analytical report further depicts historical job information associated with the corporation.

28. The system of claim 21, further comprising:
an input device, communicatively coupled to the processor, configured to receive user input specifying report parameters;
and wherein generating the interactive analytical report comprises generating the interactive analytical report using the specified report parameters.

29. The system of claim 21, wherein the interactive analytical report comprises an interactive map-based report graphically depicting quantitative data for a plurality of regions on a geographic map.

30. The system of claim 29, further comprising:
an input device, communicatively coupled to the processor, configured to receive user input specifying a level of granularity for the map;
wherein the output device is configured to display the interactive map-based report at the specified level of granularity.
